(19) United States
(12) Patent Application Publication
(10) Pub. No.: US 2026/0182486 A1
(43) Pub. Date: Jul. 2, 2026

(54) TRAVEL CONTROL SYSTEM, WORK VEHICLE, METHOD OF TRAVEL CONTROL, AND COMPUTER PROGRAM

(71) Applicant: Kubota Corporation, Osaka (JP)

(72) Inventors: Ryo ASADA, Sakai-shi (JP); Osamu YOSHIDA, Sakai-shi (JP)

(21) Appl. No.: 19/432,328

(22) Filed: Dec. 24, 2025

(30) Foreign Application Priority Data
Dec. 27, 2024 (JP) 2024-232136

(51) Int. Cl. A01B 69/04; A01B 76/00; B60K 35/10; B60K 35/22; B60K 35/28; G05D 1/229; G05D 1/648; G05D 105/15; G05D 107/20; G07C 5/00

(52) U.S. Cl. CPC A01B 69/008; A01B 76/00; B60K 35/10; B60K 35/22; B60K 35/28; G05D 1/2297; G05D 1/648; B60K 2360/11; B60K 2360/178; G05D 2105/15; G05D 2107/21; G07C 5/008

(57) ABSTRACT

A travel control system for a work vehicle includes a positioning device to output position data concerning a position of the work vehicle, and a controller configured or programmed to control operation of the work vehicle, to operate in a recording mode to record the position data as acquired while the work vehicle travels to a storage device, to operate in a reproducing mode to cause the work vehicle to travel via self-driving by controlling speed and steering of the work vehicle based on the position data recorded in the storage device, and, when a manipulation for beginning recording of the position data to the storage device is performed, to determine whether a start condition for beginning recording of the position data is satisfied or not, and to cause a notifier to output a notification as to whether the start condition is satisfied or not.

### CROSS REFERENCE TO RELATED APPLICATIONS

This application claims the benefit of priority to Japanese Patent Application No. 2024-232136 filed on Dec. 27, 2024. The entire contents of this application are hereby incorporated herein by reference.

### BACKGROUND OF THE INVENTION

### 1. Field of the Invention

The present invention relates to travel control systems, work vehicles, methods of travel control, and non-transitory computer-readable media including computer programs.

### 2. Description of the Related Art

As attempts in next-generation agriculture, research and development of smart agriculture utilizing ICT (Information and Communication Technology) and IoT (Internet of Things) is under way. Research and development is also directed to the automation and unmanned use of tractors or other work vehicles to be used in the field. For example, work vehicles which travel via automatic steering by utilizing a positioning system that is capable of precise positioning, e.g., a GNSS (Global Navigation Satellite System), are coming into practical use.

International Publication No. 2022/107586 describes a work vehicle that is capable of autonomous movement among a plurality of rows of trees in an orchard, such as a vineyard, by using an SLAM (Simultaneous Localization and Mapping) technique that simultaneously performs localization and map generation. International Publication No. 2022/107586 describes, in an orchard, a work vehicle traveling among a plurality of rows of trees, where the work vehicle performs mowing, preventive pest control, or other work by using an implement (agricultural implement) that is linked to the work vehicle.

### SUMMARY OF THE INVENTION

A work vehicle may iteratively perform the same task while traveling along the same path in a field (e.g., an orchard) in the same manner. In such a case, performing every instance of autonomous travel by, e.g., a SLAM technique will lead to an unwanted increase in the processing load for the autonomous travel.

Efficiently performing iterative operations (including traveling) of a work vehicle is required not only in agricultural machines, but also in work vehicles that are for non-agricultural uses, such as construction vehicles or snowplow vehicles. Furthermore, even in the cases of travel that does not involve work of a work vehicle (e.g., travel outside the field), it is necessary to efficiently carry out any travel that is performed iteratively along the same path.

Example embodiments of the present invention provide travel control systems, work vehicles, and methods of travel control that enable efficient performance of iterative operations (including travel and other operations) of a work vehicle.

According to example embodiments of the present invention, solutions as described in the following Items are provided.

### Item 1

A travel control system for a work vehicle, including a positioning device to output position data concerning a position of the work vehicle, and a controller configured or programmed to control operation of the work vehicle, operate in a recording mode to record to a storage device the position data as acquired while the work vehicle travels, operate in a reproducing mode to cause the work vehicle to travel via self-driving by controlling speed and steering of the work vehicle based on the position data recorded in the storage device, and when a manipulation for beginning recording of the position data to the storage device is performed, determine whether a start condition for beginning recording of the position data is satisfied or not, the start condition stipulating that all of a plurality of conditions are satisfied, and cause a notifier to output a notification as to whether the start condition is satisfied or not.

### Item 2

The travel control system of Item 1, wherein the notification includes a first notification indicating, when the start condition is determined as satisfied, that the start condition is satisfied.

### Item 3

The travel control system of Item 1 or 2, wherein the notification includes a second notification indicating, when the start condition is determined as not satisfied, a condition among the plurality of conditions that is unsatisfied.

### Item 4

The travel control system of Item 3, wherein the notifier includes a display device to display the notification, and the controller is configured or programmed to, after causing the second notification to be displayed on the display device, erase the second notification when the unsatisfied condition becomes satisfied.

### Item 5

The travel control system of any one of Items 1 to 4, wherein the notification includes a third notification indicating, when the start condition is determined as not satisfied, a manipulation to be performed in order to satisfy a condition among the plurality of conditions that is unsatisfied.

### Item 6

The travel control system of Item 5, wherein the notifier includes a display device to display the notification, and the controller is configured or programmed to, after causing the third notification to be displayed on the display device, erase the third notification when the unsatisfied condition becomes satisfied.

### Item 7

The travel control system of any one of Items 1 to 6, wherein the plurality of conditions include any two or more of that a roll angle of the work vehicle has a predetermined value or below, that a pitch angle of the work vehicle has a predetermined value or below, that the work vehicle is stopped, that a prime mover of the work vehicle is working, and that reception of a satellite signal by the positioning device is sufficient.

### Item 8

The travel control system of any one of Items 1 to 7, wherein the plurality of conditions include that the work vehicle is in a predetermined traveling mode.

### Item 9

The travel control system of any one of Items 1 to 8, wherein, in the recording mode, the work vehicle travels along a path connecting a first field and a second field, the notifier includes a display device to display the notification, and the controller is configured or programmed to, prior to the recording mode, cause the display device to display a graphical user interface (GUI) to allow a user to set the first field and the second field.

### Item 10

The travel control system of Item 9, wherein the plurality of conditions include that the work vehicle is in a predetermined region within the first field.

### Item 11

The travel control system of any one of Items 1 to 10, wherein the work vehicle includes an implement linked thereto and a linkage device to connect the implement and including a PTO shaft to supply motive power to the implement and a three-point hitch to adjust a height of the implement, and the plurality of conditions include one or more of that rotation of the PTO shaft is OFF, and that a height of the three-point hitch has a predetermined value or above.

### Item 12

The travel control system of any one of Items 1 to 11, wherein the controller is configured or programmed to, when a manipulation for ending the recording mode is performed by a user, determine whether an end condition for ending the recording mode is satisfied or not, the end condition stipulating that all of a plurality of conditions are satisfied, and cause the notifier to output another notification as to whether the end condition is satisfied or not.

### Item 13

The travel control system of Item 12, wherein the another notification includes a fourth notification indicating, when the end condition is determined as satisfied, that the end condition is satisfied.

### Item 14

The travel control system of Item 12 or 13, wherein the another notification includes a fifth notification indicating, when the end condition is determined as not satisfied, a condition among the plurality of conditions defining the end condition that is unsatisfied.

### Item 15

The travel control system of Item 14, wherein the notifier includes a display device to display the notification, the controller is configured or programmed to, after causing the fifth notification to be displayed on the display device, erase the fifth notification when the unsatisfied condition becomes satisfied.

### Item 16

The travel control system of any one of Items 12 to 15, wherein the another notification includes a sixth notification indicating, when the end condition is determined as not satisfied, a manipulation to be performed in order to satisfy a condition among the plurality of conditions defining the end condition that is unsatisfied.

### Item 17

The travel control system of Item 16, wherein the notifier includes a display device to display the notification, the controller is configured or programmed to, after causing the sixth notification to be displayed on the display device, erase the sixth notification when the unsatisfied condition becomes satisfied.

### Item 18

A work vehicle including the travel control system of any one of Items 1 to 17, a travel device including a wheel responsible for steering, and a driver to drive the travel device, wherein, in the reproducing mode, the controller is configured or programmed to cause the work vehicle to travel via self-driving by controlling the driver based on the position data recorded in the storage device.

### Item 19

A method of travel control for a work vehicle, to be executed by a controller configured or programmed to control operation of the work vehicle and operate in a recording mode and a reproducing mode, the method including, in the recording mode, recording position data concerning a position of the work vehicle as acquired while the work vehicle travels to a storage device, in the reproducing mode, causing the work vehicle to travel via self-driving by controlling speed and steering of the work vehicle based on the position data recorded in the storage device, and, when a manipulation for beginning recording of the position data to the storage device is performed, determining whether a start condition for beginning recording of the position data is satisfied or not, the start condition stipulating that all of a plurality of conditions are satisfied, and causing a notifier to output a notification as to whether the start condition is satisfied or not.

### Item 20

A non-transitory computer-readable medium including a computer program to be executed by a processor in a controller configured or programmed to control operation of a work vehicle and operate in a recording mode and a reproducing mode, the computer program being executable to cause the processor to perform, in the recording mode, recording position data concerning a position of the work vehicle as acquired while the work vehicle travels to a storage device, in the reproducing mode, causing the work vehicle to travel via self-driving by controlling speed and steering of the work vehicle based on the position data recorded in the storage device, and, when a manipulation for beginning recording of the position data to the storage device is performed, determining whether a start condition for beginning recording of the position data is satisfied or not, the start condition stipulating that all of a plurality of conditions are satisfied, and causing a notifier to output a notification as to whether the start condition is satisfied or not.

### Item 21

A controller configured or programmed to perform the method of travel control of Item 19.

### Item 22

A non-transitory computer-readable medium including a computer program to be executed by a computer configured or programmed to control operation of a work vehicle, wherein the computer program is executable to cause the computer to perform steps of the method of travel control of Item 19.

### Item 23

A non-transitory computer-readable medium including a computer program medium including a computer program to be executed by a computer configured or programmed to control operation of a work vehicle, wherein the computer program is executable to cause the computer to perform the method of travel control of Item 19.

### Item 24

A travel control system for a work vehicle, the travel control system including a positioning device to output position data concerning a position of the work vehicle, and the controller of Item 21.

### Item 25

A controller configured or programmed to control operation of a work vehicle, operate in a recording mode to record position data concerning a position of the work vehicle as acquired while the work vehicle travels to a storage device, operate in a reproducing mode to cause the work vehicle to travel via self-driving by controlling speed and steering of the work vehicle based on the position data recorded in the storage device, and, when a manipulation for beginning recording of the position data to the storage device is performed, determine whether a start condition for beginning recording of the position data is satisfied or not, the start condition stipulating that all of a plurality of conditions are satisfied, and cause a notifier to output a notification as to whether the start condition is satisfied or not.

### Item 26

A travel control system for a work vehicle, the travel control system including a positioning device to output position data concerning a position of the work vehicle, and the controller of Item 25.

### Item 27

A controller including one or more processors, and one or more memories storing a computer program executable by the controller to cause the one or more processors to perform steps of the method of travel control of Item 19.

### Item 28

A travel control system including the controller of Item 27, and a first driver to drive a travel device of the work vehicle, wherein, in the reproducing mode, the controller is configured or programmed to cause the work vehicle to travel via self-driving by controlling the first driver based on the position data recorded in the storage device.

Example embodiments of the present invention may be implemented using devices, systems, methods, integrated circuits, computer programs, non-transitory computer-readable storage media, or any combination thereof. The computer-readable storage media may be inclusive of volatile storage media, or non-volatile storage media. The device may include a plurality of devices. In the case where the device includes two or more devices, the two or more devices may be provided within a single apparatus, or divided over two or more separate apparatuses.

According to example embodiments of the present invention, travel control systems, work vehicles, and methods of travel control that enable efficient performance of iterative operations (including travel and other operations) of a work vehicle are provided. The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a side view schematically showing an example of a work vehicle according to an example embodiment of the present invention.

FIG. 2 is a block diagram schematically showing an example configuration for a work vehicle and an implement according to an example embodiment of the present invention.

FIG. 3A is a block diagram showing a schematic example configuration for a travel control system according to an example embodiment of the present invention.

FIG. 3B is a block diagram showing an example configuration for a controller included in a travel control system according to an example embodiment of the present invention.

FIG. 4 is a schematic diagram showing an example configuration for a travel control system according to an example embodiment of the present invention.

FIG. 5A is a diagram schematically showing an example of a path to be traveled by a work vehicle according to an example embodiment of the present invention in a recording mode.

FIG. 5B is a diagram schematically showing a path to be traveled by a work vehicle according to an example embodiment of the present invention in a reproducing mode.

FIG. 6 is a diagram showing an example of waypoint data to be recorded to a storage device.

FIG. 7A is a flowchart showing an example processing to be performed by the controller in the recording mode.

FIG. 7B is a flowchart showing an example processing to be performed by the controller in the recording mode.

FIG. 8 is a flowchart showing an example processing to be performed by the controller in the recording mode.

FIG. 9A shows an example screen image to be displayed on an operation terminal operated by a user.

FIG. 9B shows an example screen image to be displayed on an operation terminal operated by a user.

FIG. 9C shows an example screen image to be displayed on an operation terminal operated by a user.

FIG. 9D shows an example screen image to be displayed on an operation terminal operated by a user.

FIG. 10A shows an example screen image to be displayed on an operation terminal operated by a user.

FIG. 10B shows an example screen image to be displayed on an operation terminal operated by a user.

FIG. 10C shows an example screen image to be displayed on an operation terminal operated by a user.

FIG. 11A shows an example screen image to be displayed on an operation terminal operated by a user.

FIG. 11B shows an example screen image to be displayed on an operation terminal operated by a user.

FIG. 11C shows an example screen image to be displayed on an operation terminal operated by a user.

FIG. 12A shows an example screen image to be displayed on an operation terminal operated by a user.

FIG. 12B shows an example screen image to be displayed on an operation terminal operated by a user.

FIG. 12C shows an example screen image to be displayed on an operation terminal operated by a user.

FIG. 13A shows an example screen image to be displayed on an operation terminal operated by a user.

FIG. 13B shows an example screen image to be displayed on an operation terminal operated by a user.

FIG. 13C shows an example screen image to be displayed on an operation terminal operated by a user.

FIG. 14 is a flowchart showing an example processing to be performed by the controller in the reproducing mode.

FIG. 15 is a schematic diagram for describing an example processing to be performed by the controller.

### DETAILED DESCRIPTION OF THE EXAMPLE EMBODIMENTS

In the present specification, a “work vehicle” means a vehicle for use in performing work in a work area. A “work area” is any place where work may be performed, e.g., a field, a mountain forest, or a construction site. A “field” is any place where agricultural work may be performed, e.g., an orchard, an agricultural field, a paddy field, a cereal farm, or a pasture. A work vehicle can be an agricultural machine such as a tractor, a rice transplanter, a combine, a vehicle for crop management, or a riding mower, or a vehicle for non-agricultural purposes such as a construction vehicle or a snowplow vehicle. A work vehicle may be configured so that an implement (also referred to as a “task device” or a “task apparatus”) that is suitable for the content of work can be attached to at least one of its front and its rear. In particular, an implement that is attached to an agricultural tractor may be referred to as an “agricultural implement”. Traveling of a work vehicle that occurs while the work vehicle performs work by using an implement may be referred to as “tasked travel”. The “operation” of a work vehicle includes not only travel of the work vehicle but also other operations.

“Self-driving” means controlling the travel of a vehicle based on the action of a controller, rather than through manual operation of a driver. During self-driving, not only the travel of the vehicle, but also the task operation (e.g., the operation of the implement) may also be automatically controlled. A vehicle that is traveling via self-driving is said to be “self-traveling”. The controller may be configured or programmed to control at least one of steering, adjustment of traveling speed, and starting and stopping of travel as are necessary for the travel of vehicle. In the case of controlling a work vehicle having an implement attached thereto, the controller may be configured or programmed to control operations such as raising or lowering of the implement, starting and stopping of the operation of the implement, and the like. Travel via self-driving includes not only the travel of a vehicle toward a destination along a predetermined path, but also the travel of merely following a target of tracking. A vehicle performing self-driving may operate not only in a self-driving mode but also in a manual driving mode of traveling through manual operation of the driver. Traveling through manual operation of the driver is referred to as “manual traveling”. “Manual operation of a driver” includes not only manual operation by a driver on the vehicle, but also remote manipulation by a driver (operator) outside the vehicle. A vehicle performing self-driving may travel partly based on manual operation of the driver. The steering of a vehicle that is based on the action of a controller, rather than manual operation of the driver, is referred to as “automatic steering”. A portion or an entirety of the controller may be external to the vehicle. Between the vehicle and a controller that is external to the vehicle, communication of control signals, commands, data, or the like may be performed. A vehicle performing self-driving may autonomously travel while sensing the surrounding environment, without any person being involved in the control of the travel of the vehicle. A vehicle that is capable of autonomous travel can travel in an unmanned manner. During autonomous travel, detection of obstacles and avoidance of obstacles may be performed.

A “crop row” is a row of agricultural items, trees, or other plants that may grow in rows on a field, e.g., an orchard or an agricultural field, or in a forest or the like. In the present specification, a “crop row” encompasses a “row of trees”.

Hereinafter, example embodiments of the present invention will be described more specifically. Note however that unnecessarily detailed descriptions may be omitted. For example, detailed descriptions on what is well known in the art or redundant descriptions on what is substantially the same configuration may be omitted. This is to avoid lengthy description, and facilitate the understanding of those skilled in the art. The accompanying drawings and the following description, which are provided by the present inventors so that those skilled in the art can sufficiently understand example embodiments of the present invention, are not intended to limit the scope of claims. In the following description, component elements having identical or similar functions are denoted by identical reference numerals.

The following example embodiments are only exemplary, and the technique according to the present invention is not limited to the following example embodiments. For example, numerical values, shapes, materials, steps, orders of steps, etc., that are indicated in the following example embodiments are only exemplary, and admit of various modifications so long as it makes technological sense. Any one implementation may be combined with another.

Hereinafter, as one example, an example embodiment where the work vehicle is a tractor for use in agricultural work in a field such as an orchard will be described. Without being limited to tractors, the techniques according to example embodiments of the present invention are also applicable to other type of agricultural machines such as a rice transplanter, a combine, a vehicle for crop management, or a riding lawn mower, for example. The techniques according to example embodiments of the present invention are also applicable to vehicles for non-agricultural purposes such as a construction vehicle or a snowplow vehicle. Furthermore, the techniques according to example embodiments of the present invention are applicable to travel of a work vehicle other than in work areas, and also to travel that does not involve any work by the work vehicle.

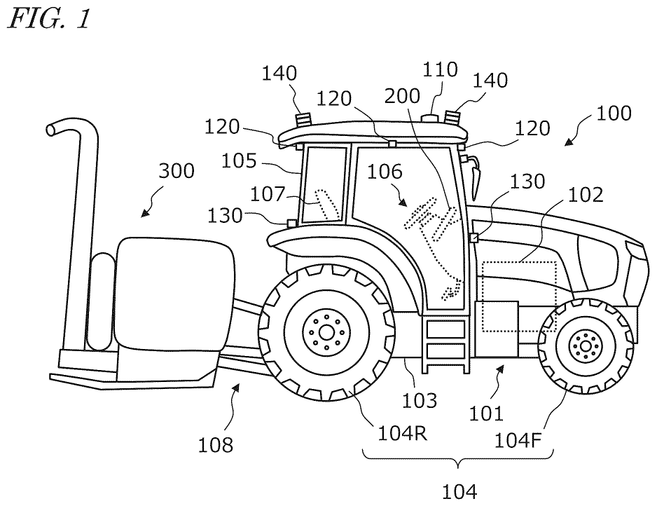

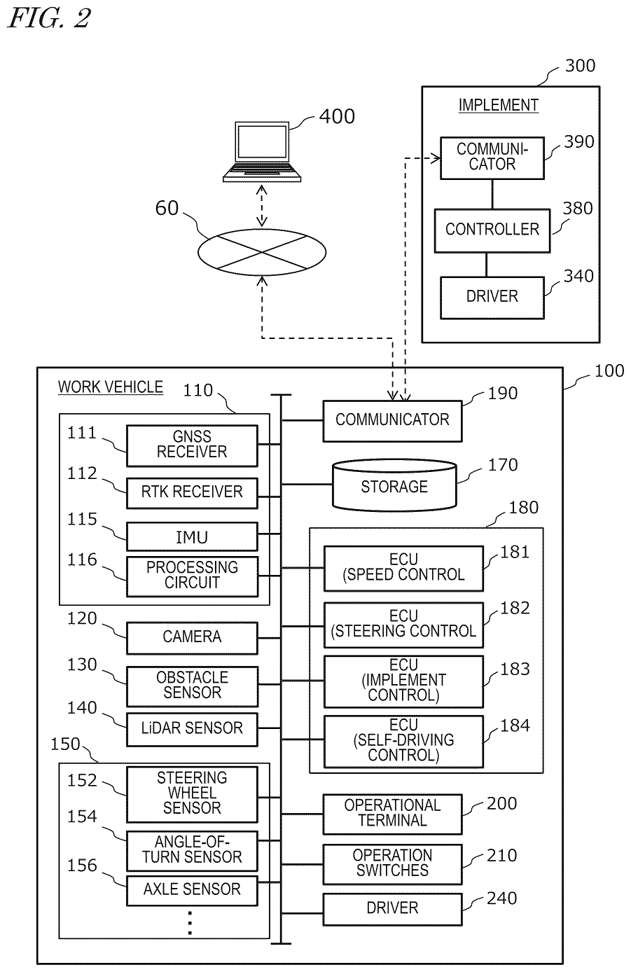

FIG. 1 is a side view schematically showing an example of a work vehicle 100 and an implement 300 that is linked to the work vehicle 100. FIG. 2 is a block diagram schematically showing an example configuration for the work vehicle 100 and the implement 300.

As shown in in FIG. 1 and FIG. 2, the work vehicle 100 includes a positioning device 110 to output position data concerning the position of the work vehicle 100 (e.g., a GNSS unit), and a controller 180 configured or programmed to control the operation of the work vehicle 100.

The work vehicle 100 may further include a sensor group 150 to output sensor data concerning the state of the work vehicle 100. The sensor group 150 includes one or more internal sensors. An “internal sensor” is inclusive of a variety of sensors that detect the state of the work vehicle 100.

The work vehicle 100 may further include a plurality of external sensors to sense the surroundings of the work vehicle 100. An “external sensor” is a sensor that senses the external state of the work vehicle. In the example of FIG. 1, the external sensors include a plurality of LiDAR sensors 140, a plurality of cameras 120, and a plurality of obstacle sensors 130.

In addition to the positioning device 110, the cameras 120, the obstacle sensors 130, and the LiDAR sensors 140, the sensor group 150, a storage device 170, the controller 180, and an operation terminal 200, the work vehicle 100 in the example of FIG. 2 also includes a communicator 190, operation switches 210, and a driver 240 (which may be referred to as a “first driver”). These component elements are communicably connected to one another via a bus.

As shown in FIG. 1, the work vehicle 100 includes a vehicle body 101, a prime mover (engine) 102, and a transmission 103. On the vehicle body 101, a travel device, which includes wheels 104 with tires, and a cabin 105 are provided. The travel device includes four wheels 104, and axles to cause the four wheels to rotate, and braking device (brakes) to brake on each axle. The wheels 104 include a pair of front wheels 104F and a pair of rear wheels 104R. Inside the cabin 105, a driver's seat 107, a steering device 106, an operation terminal 200, and switches for manipulation are provided. The front wheels 104F and/or the rear wheels 104R may be replaced by a plurality of wheels with a track (crawlers); rather than wheels with tires, attached thereto.

The prime mover 102 may be a diesel engine, for example. Instead of a diesel engine, an electric motor may be used. The transmission 103 can change the propulsion and the moving speed of the work vehicle 100 through a speed changing mechanism. The transmission 103 can also switch between forward travel and backward travel of the work vehicle 100.

The steering device 106 includes a steering wheel, a steering shaft connected to the steering wheel, and a power steering device to assist in the steering by the steering wheel. The front wheels 104F are the wheels responsible for steering, such that changing their angle of turn (also referred to as “steering angle”) can cause a change in the traveling direction of the work vehicle 100. The steering angle of the front wheels 104F can be changed by manipulating the steering wheel. The power steering device includes a hydraulic device or an electric motor to supply an assisting force for changing the steering angle of the front wheels 104F. When automatic steering is performed, under the control of the controller included in the work vehicle 100, the steering angle may be automatically adjusted by the power of the hydraulic device or the electric motor.

A linkage device 108 is provided at the rear of the vehicle body 101. The linkage device 108 includes, e.g., a three-point linkage (also referred to as a “three-point hitch” or a “three-point link”), a PTO (Power Take Off) shaft, a universal joint, and a communication cable. The linkage device 108 allows the implement 300 to be attached to, or detached from, the work vehicle 100. The linkage device 108 is able to raise or lower the three-point hitch with a hydraulic device, for example, thus changing the position or attitude of the implement 300. Moreover, motive power can be sent from the work vehicle 100 to the implement 300 via the universal joint. While towing the implement 300, the work vehicle 100 allows the implement 300 to perform a predetermined task. The linkage device may be provided at the front portion of the vehicle body 101. In that case, the implement can be connected at the front portion of the work vehicle 100.

Although the implement 300 shown in FIG. 1 is a sprayer to spray a chemical agent onto a crop, the implement 300 is not limited to a sprayer. For example, any arbitrary task device such as a mower, a seeder, a spreader, a rake, a baler, a harvester, a plow, a harrow, or a rotary tiller may be connected to the work vehicle 100 for use.

The positioning device 110 receives satellite signals (also referred to as GNSS signals) that are transmitted from a plurality of GNSS satellites, and performs positioning based on the satellite signals. GNSS is a collective term for satellite positioning systems such as the GPS (Global Positioning System), QZSS (Quasi-Zenith Satellite System, e.g., MICHIBIKI), GLONASS, Galileo, and BeiDou. Although the positioning device 110 in the present example embodiment is located above the cabin 105, it may be located at any other position.

As shown in FIG. 2, the positioning device 110 includes a GNSS receiver 111, an RTK receiver 112, and a processing circuit 116. The positioning device 110 may further include an inertial measurement unit (IMU) 115.

The GNSS receiver 111 includes an antenna to receive signals from the GNSS satellites, and a processing circuit to determine the position of the work vehicle 100 based on the signals received by the antenna. The GNSS receiver 111 in the GNSS unit 110 receives satellite signals transmitted from the plurality of GNSS satellites and generates GNSS data based on the satellite signals. The GNSS data is generated in a predetermined format such as, for example, the NMEA-0183 format. The GNSS data may include, for example, the ID number, the angle of elevation, the azimuth angle, and a value representing the reception intensity of each of the satellites from which the satellite signals are received.

The positioning device 110 may perform positioning of the work vehicle 100 by utilizing an RTK (Real Time Kinematic)-GNSS. In the positioning based on the RTK-GNSS, not only satellite signals transmitted from a plurality of GNSS satellites, but also a correction signal that is transmitted from a reference station is used. The reference station may be located near the work area where the work vehicle 100 performs tasked travel (e.g., at a position within 10 km of the work vehicle 100). The reference station generates a correction signal of, for example, an RTCM format based on the satellite signals received from the plurality of GNSS satellites, and transmits the correction signal to the positioning device 110. The RTK receiver 112, which includes an antenna and a modem, receives the correction signal transmitted from the reference station. Based on the correction signal, the processing circuit 116 of the positioning device 110 corrects the results of the positioning performed by the GNSS receiver 111. Use of the RTK-GNSS enables positioning with an accuracy on the order of several centimeters of errors, for example. Positional information including latitude, longitude, and altitude information is acquired through the highly accurate positioning by the RTK-GNSS. The positioning device 110 calculates the position of the work vehicle 100 as frequently as, for example, one to ten times per second. Note that the positioning method is not limited to being performed by using an RTK-GNSS, any arbitrary positioning method (e.g., an interferometric positioning method or a relative positioning method) that provides positional information with the necessary accuracy can be used. For example, positioning may be performed by utilizing a VRS (Virtual Reference Station) or a DGPS (Differential Global Positioning System).

The positioning device 110 according to the present example embodiment may further include the IMU 115. With the inclusion of the IMU 115, the positioning device 110 can complement position data by utilizing signals from the IMU. The data acquired by the IMU 115 can be used to complement the position data based on the satellite signals, so as to improve the performance of positioning.

The IMU 115 may include a 3-axis accelerometer and a 3-axis gyroscope. The IMU 115 may include a direction sensor such as a 3-axis geomagnetic sensor. The IMU 115 functions as a motion sensor which can output signals representing parameters such as acceleration, velocity, displacement, and attitude of the work vehicle 100. Based not only on the satellite signals and the correction signal but also on a signal that is output from the IMU 115, the processing circuit 116 can estimate the position and orientation of the work vehicle 100 with a higher accuracy. The signal that is output from the IMU 115 may be used for the correction or complementation of the position that is calculated based on the satellite signals and the correction signal. The IMU 115 outputs a signal more frequently than the GNSS receiver 111. For example, the IMU 115 outputs a signal as frequently as approximately several ten times to several thousand times per second. Utilizing this signal that is output highly frequently, the processing circuit 116 allows the position and orientation of the work vehicle 100 to be measured more frequently (e.g., about 10 Hz or above). Instead of the IMU 115, a 3-axis accelerometer and a 3-axis gyroscope may be separately provided. The IMU 115 may be provided as a separate device from the positioning device 110.

The sensor group 150 may include various sensors to detect the state of the work vehicle 100 or the implement 300 (i.e., internal sensors). For example, the sensor group 150 may include a steering wheel sensor 152, an angle-of-turn sensor 154, and an axle sensor 156.

The steering wheel sensor 152 measures the angle of rotation of the steering wheel of the work vehicle 100. The angle-of-turn sensor 154 measures the angle of turn of the front wheels 104F, which are the wheels responsible for steering. Measurement values by the steering wheel sensor 152 and the angle-of-turn sensor 154 may be used for steering control by the controller 180.

The axle sensor 156 measures the rotational speed, i.e., the number of revolutions per unit time, of an axle that is connected to the wheels 104. The axle sensor 156 may be a sensor including a magnetoresistive element (MR), a Hall generator, or an electromagnetic pickup, for example. The axle sensor 156 outputs a numerical value indicating the number of revolutions per minute (unit: rpm) of the axle, for example. The axle sensor 156 is used to measure the speed of the work vehicle 100. Measurement values from the axle sensor 156 can be utilized for the speed control by the controller 180.

The storage device 170 includes one or more storage media such as a flash memory or a magnetic disc. The storage device 170 stores various data that is generated by the positioning device 110, the cameras 120, the obstacle sensors 130, and the LiDAR sensors 140, the sensor group 150, and the controller 180. The data that is stored by the storage device 170 may include an environment map of the environment where the work vehicle 100 travels, an obstacle map that is consecutively generated during travel, and path data for self-driving. The storage device 170 also stores a computer program(s) to cause each of the ECUs in the controller 180 to perform various operations described below. Such a computer program(s) may be provided to the work vehicle 100 via a storage medium (e.g., a semiconductor memory, an optical disc, etc.) or through telecommunication lines (e.g., the Internet). Such a computer program(s) may be marketed as commercial software.

The controller 180 includes the plurality of ECUs. The plurality of ECUs include, for example, the ECU 181 for speed control, the ECU 182 for steering control, the ECU 183 for implement control, and the ECU 184 for self-driving control.

The ECU 181 is configured or programmed to control the prime mover 102, the transmission 103, and brakes included in the driver 240, thus controlling the speed of the work vehicle 100.

The ECU 182 is configured or programmed to control the hydraulic device or the electric motor included in the steering device 106 based on a measurement value of the steering wheel sensor 152, thus controlling the steering of the work vehicle 100.

In order to cause the implement 300 to perform a desired operation, the ECU 183 is configured or programmed to control the operations of the three-point hitch, the PTO shaft, and the like that are included in the linkage device 108. Also, the ECU 183 is configured or programmed to generate a signal to control the operation of the implement 300, and transmits this signal from the communicator 190 to the implement 300.

Based on data output from the positioning device 110, the cameras 120, the obstacle sensors 130, and the LiDAR sensors 140, and the sensor group 150, the ECU 184 is configured or programmed to perform computation and control for achieving self-driving. For example, the ECU 184 is configured or programmed to estimate the position of the work vehicle 100 based on the data output from at least one of the positioning device 110, the cameras 120, and the LiDAR sensors 140. In a situation where a sufficiently high reception intensity exists for the satellite signals from the GNSS satellites, the ECU 184 may be configured or programmed to determine the position of the work vehicle 100 based only on the data output from the positioning device 110. On the other hand, in an environment where obstructions, such as trees, that may hinder reception of the satellite signals exist around the work vehicle 100, e.g., an orchard, the ECU 184 is configured or programmed to estimate the position of the work vehicle 100 by using the data output from the LiDAR sensors 140 or the cameras 120. During self-driving, the ECU 184 is configured or programmed to perform computation necessary for the work vehicle 100 to travel along a target path, based on the estimated position of the work vehicle 100. The ECU 184 sends the ECU 181 a command to change the speed, and sends the ECU 182 a command to change the steering angle. In response to the command to change the speed, the ECU 181 is configured or programmed to control the prime mover 102, the transmission 103, or the brakes to change the speed of the work vehicle 100. In response to the command to change the steering angle, the ECU 182 is configured or programmed to control the steering device 106 to change the steering angle.

Through the actions of these ECUs, the controller 180 is configured or programmed to realize self-traveling. During self-traveling, the controller 180 is configured or programmed to control the driver 240 based on the measured or estimated position of the work vehicle 100 and on the consecutively-generated target path. As a result, the controller 180 can cause the work vehicle 100 to travel along the target path.

The plurality of ECUs included in the controller 180 can communicate with one another in accordance with a vehicle bus standard such as, for example, a CAN (Controller Area Network). Instead of a CAN, faster communication methods such as Automotive Ethernet (registered trademark) may be used. Although the ECUs 181 to 184 are illustrated as individual blocks in FIG. 2, the function of each of the ECU 181 to 184 may be implemented by a plurality of ECUs. Alternatively, an onboard computer that integrates the functions of at least some of the ECUs 181 to 184 may be provided. The controller 180 may include ECUs other than the ECUs 181 to 184, and any number of ECUs may be provided in accordance with functionality. Each ECU includes a processing circuit including one or more processors.

The cameras 120 may be provided at the front/rear/right/left of the work vehicle 100, for example. The cameras 120 image the surrounding environment of the work vehicle 100 and generate image data. The images acquired with the cameras 120 may be transmitted to the terminal device, which is responsible for remote monitoring, for example. The images may be used to monitor the work vehicle 100 during unmanned driving. The cameras 120 may be provided according to the needs, and any number of them may be provided.

The LiDAR sensors 140 are one example of external sensors that output sensor data indicating a distribution of geographic features around the work vehicle 100. In the example of FIG. 1, two LiDAR sensors 140 are provided on the cabin 105, at the front and the rear. The LiDAR sensors 140 may be provided at other positions (e.g., on a lower portion of a front face of the vehicle body 101). While the work vehicle 100 is traveling, each LiDAR sensor 140 repeatedly outputs sensor data representing the distances and directions of measurement points on objects existing in the surrounding environment, or two-dimensional or three-dimensional coordinate values of such measurement points. The number of LiDAR sensors 140 is not limited to two, but may be one, or three or more.

The LiDAR sensors 140 may be configured to output two-dimensional or three-dimensional point cloud data as sensor data. In the present specification, “point cloud data” broadly means data indicating a distribution of multiple reflection points that are observed with the LiDAR sensors 140. The point cloud data may include coordinate values of each reflection point in a two-dimensional space or a three-dimensional space or information indicating the distance and direction of each reflection point, for example. The point cloud data may include information of luminance of each reflection point. The LiDAR sensors 140 may be configured to repeatedly output point cloud data with a pre-designated cycle, for example. Thus, the external sensors may include one or more LiDAR sensors 140 that output point cloud data as sensor data.

The sensor data that is output from the LiDAR sensors 140 is processed by a controller that controls self-traveling of the work vehicle 100. During travel of the work vehicle 100, based on the sensor data that is output from the LiDAR sensors 140, the controller can be configured or programmed to consecutively generate an obstacle map indicating a distribution of objects existing around the work vehicle 100. The controller may be configured or programmed to generate an environment map by joining together obstacle maps with the use of an algorithm such as SLAM, for example, during self-traveling. The controller can be configured or programmed to perform estimation of the position and orientation of the work vehicle 100 (i.e., localization) by matching the sensor data against the environment map.

The plurality of obstacle sensors 130 shown in FIG. 1 are provided at the front and the rear of the cabin 105. The obstacle sensors 130 may be located at other positions. For example, one or more obstacle sensors 130 may be located at any position at the sides, the front, or the rear of the vehicle body 101. The obstacle sensors 130 may include, for example, laser scanners or ultrasonic sonars. The obstacle sensors 130 may be used to detect obstacles in the surroundings during self-traveling to cause the work vehicle 100 to halt or detour around the obstacles.

The controller of the work vehicle 100 may be configured or programmed to utilize, for positioning, the sensor data acquired with the sensing devices such as the cameras 120 or the LIDAR sensors 140, in addition to the results of positioning provided by the positioning device 110. In the case where geographic features serving as characteristic points exist in the environment that is traveled by the work vehicle 100, as in the case of an agricultural road, a forest road, a general road, or an orchard, the position and the orientation of the work vehicle 100 can be estimated with a high accuracy based on data that is acquired with the cameras 120 or the LiDAR sensors 140 and on an environment map that is previously stored in the storage device. By correcting or complementing position data based on the satellite signals using the data acquired with the cameras 120 or the LiDAR sensors 140, it becomes possible to identify the position of the work vehicle 100 with a higher accuracy.

The work vehicle 100 and the implement 300 can communicate with each other via a communication cable that is included in the linkage device 108. The work vehicle 100 is able to communicate with a terminal device 400 for remote monitoring via a network 60. The terminal device 400 may be any arbitrary computer, e.g., a personal computer (PC), a laptop computer, a tablet computer, or a smartphone, for example.

The implement 300 includes a driver 340 (which may be referred to as the “second driver”), a driver 340, a controller 380, and a communicator 390. Note that FIG. 2 shows component elements which are relatively closely related to the operations of self-driving by the work vehicle 100, while other components are omitted from illustration.

The cameras 120 are imagers that image the surrounding environment of the work vehicle 100. Each camera 120 includes an image sensor such as a CCD (Charge Coupled Device) or a CMOS (Complementary Metal Oxide Semiconductor), for example. In addition, each camera 120 may include an optical system including one or more lenses and a signal processing circuit. During travel of the work vehicle 100, the cameras 120 image the surrounding environment of the work vehicle 100, and generate image (e.g., motion picture) data. The cameras 120 are able to capture motion pictures at a frame rate of 3 frames/second (fps: frames per second) or greater, for example. The images generated by the cameras 120 may be used by a remote supervisor to check the surrounding environment of the work vehicle 100 with the terminal device 400, for example. The images generated by the cameras 120 may also be used for the purpose of positioning or detection of obstacles. As shown in FIG. 1, the plurality of cameras 120 may be provided at different positions on the work vehicle 100, or a single camera 120 may be provided. A visible camera(s) to generate visible images and an infrared camera(s) to generate infrared images may be separately provided. Both of a visible camera(s) and an infrared camera(s) may be provided as a camera(s) to generate images for monitoring purposes. The infrared camera(s) may also be used for detection of obstacles at nighttime.

An obstacle sensor 130 detects objects around the work vehicle 100. The obstacle sensor 130 may include a laser scanner or an ultrasonic sonar, for example. When an object exists at a position closer to the obstacle sensor 130 than a predetermined distance, the obstacle sensor 130 outputs a signal indicating the presence of an obstacle. A plurality of obstacle sensors 130 may be provided at different positions of the work vehicle 100. For example, a plurality of laser scanners and a plurality of ultrasonic sonars may be located at different positions of the work vehicle 100. Providing a multitude of obstacle sensors 130 can reduce blind spots in monitoring obstacles around the work vehicle 100.

The driver 240 includes various types of devices required to cause the work vehicle 100 to travel and to drive the implement 300; for example, the prime mover 102, the transmission 103, the steering device 106, the linkage device 108 and the like described above. The prime mover 102 may include an internal combustion engine such as, for example, a diesel engine. The driver 240 may include an electric motor for traction instead of, or in addition to, the internal combustion engine.

The communicator 190 is a device including a circuit to communicate with the implement 300 and the terminal device 400. The communicator 190 includes circuitry to perform exchanges of signals complying with an ISOBUS standard such as ISOBUS-TIM, for example, between itself and the communicator 390 of the implement 300. This allows the implement 300 to perform a desired operation, or allows information to be acquired from the implement 300. The communicator 190 may further include an antenna and a communication circuit to exchange signals via the network 60 with the terminal device 400. The network 60 may include a 3G, 4G, 5G, or any other cellular mobile communications network and the Internet, for example. The communicator 190 may have a function of communicating with a mobile terminal that is used by a supervisor who is situated near the work vehicle 100. With such a mobile terminal, communication may be performed based on any arbitrary wireless communication standard, e.g., Wi-Fi (registered trademark), 3G, 4G, 5G or any other cellular mobile communication standard, or Bluetooth (registered trademark).

The operation terminal 200 is a terminal for the user to perform a manipulation related to the travel of the work vehicle 100 and the operation of the implement 300, and is also referred to as a virtual terminal (VT). The operation terminal 200 may include a display device such as a touch screen panel, and/or one or more buttons. The display device may be a display such as a liquid crystal display or an organic light-emitting diode (OLED) display, for example. By manipulating the operation terminal 200, the user can perform various manipulations, such as, for example, switching ON/OFF the self-driving mode, switching ON/OFF a recording (teaching) mode and a reproducing (playback) mode as will be described below/, and switching ON/OFF the implement 300. At least some of these manipulations may also be realized by manipulating the operation switches 210. The operation terminal 200 may be configured so as to be detachable from the work vehicle 100. A user who is at a remote place from the work vehicle 100 may manipulate the detached operation terminal 200 to control the operation of the work vehicle 100. The operation terminal 200 may include a storage device. In place of the storage device 170, the storage device in the operation terminal 200 may store various data that is necessary for the operation of the work vehicle 100.

The driver 340 in the implement 300 shown in FIG. 2 performs necessary operations for the implement 300 to perform predetermined tasks. The driver 340 includes a device that is adapted to the use of the implement 300, e.g., a hydraulic device, an electric motor, or a pump. The controller 380 is configured or programmed to control the operation of the driver 340. In response to signals that are transmitted from the work vehicle 100 via the communicator 390, the controller 380 is configured or programmed to cause the driver 340 to perform various operations. Moreover, a signal that is in accordance with the state of the implement 300 may be transmitted from the communicator 390 to the work vehicle 100.

A travel control system according to an example embodiment of the present invention will be described. The travel control system according to the present example embodiment of the present invention is applicable to the above-described work vehicle 100, for example. Although the examples of FIG. 1 and FIG. 2 illustrate the implement 300 as being linked to the work vehicle 100, it is not essentially required for the implement 300 to be linked to the work vehicle 100. In other words, the travel control system according to the present example embodiment of the present invention is applicable also to the work vehicle 100 without the implement 300 linked thereto.

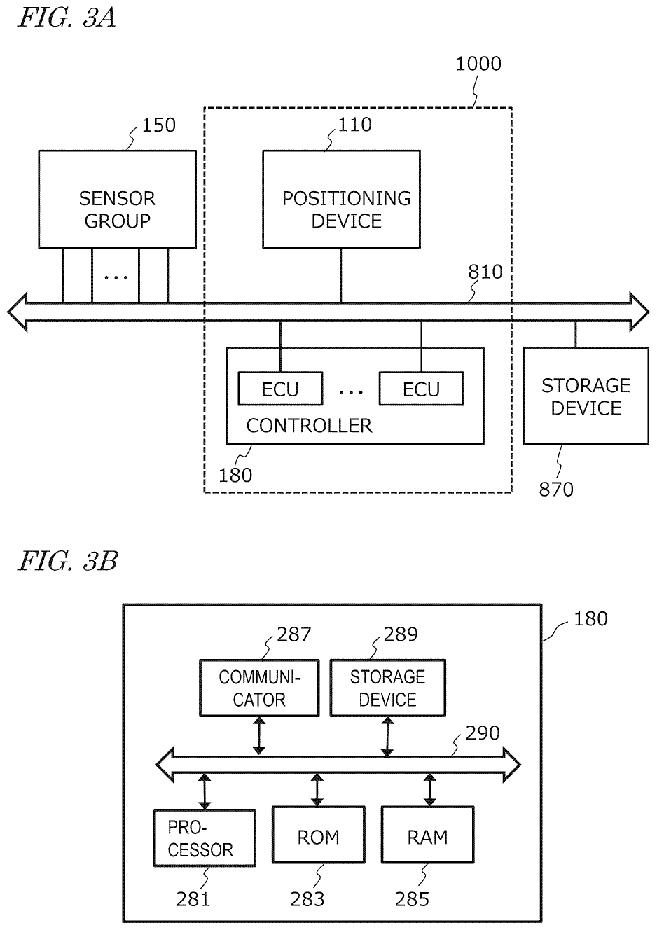

FIG. 3A is a block diagram showing a schematic example configuration for the travel control system 1000 according to the present example embodiment of the present invention. As shown in FIG. 3A, the travel control system 1000 according to the present example embodiment includes a positioning device 110 to detect the position of the work vehicle 100 and output position data, and a controller 180 configured or programmed to control the operation of the work vehicle 100. In the present example embodiment, as shown in FIG. 2, the positioning device 110 and the controller 180 are provided in the work vehicle 100. Working in cooperation with the positioning device 110, the controller 180 is configured or programmed to function as the travel control system 1000 of the work vehicle 100. The controller 180 and the positioning device 110 may be communicably connected to one another via the bus 810.

FIG. 3A together shows one or more internal sensors (sensor group) 150 to output sensor data concerning the state of the work vehicle 100. The sensor group 150 may be included as part of the travel control system 1000, or be external elements to the travel control system 1000. In the present example embodiment, as shown in FIG. 2, the sensor group 150 is provided in the work vehicle 100. The sensor group 150 may be communicably connected to the controller 180 and the positioning device 110 via the bus 810.

FIG. 3A also shows a storage device 870, to which information that is acquired by the controller 180 is recorded. The storage device 870 may be included in the travel control system 1000, or be an external element to the travel control system 1000. The storage device 870 may be mounted in the work vehicle 100, or mounted in the implement 300. The storage device 870 may be communicably connected to the controller 180 via the 810. For example, the storage device 870 may be the storage device 170 shown in FIG. 2, or a storage device that is included in the operation terminal 200. The operation terminal 200 may be included in the travel control system 1000. The storage device 870 may be located outside of the work vehicle 100 and the implement 300. When located outside of the work vehicle 100 and the implement 300, the storage device 870 may be connected to the controller 180 via a communications network. The storage device 870 may be included in a server computer that is connected to the controller 180 via the communications network.

In the example shown in FIG. 1, the positioning device 110 is mounted to the work vehicle 100. However, the positioning device 110 may be mounted to the implement 300 that is linked to the work vehicle 100. In addition to or instead of the positioning device mounted to the work vehicle 100, a positioning device (e.g., a GNSS unit) that is mounted to the implement 300 may function as a positioning device 110 of the travel control system 1000. Strictly speaking, a position that is measured by a positioning device that is mounted to the work vehicle 100 or the implement 300 is the position of a point at which the positioning device exists, but this position is referred to as the “position of the work vehicle” in the present specification.

Without being limited to the steering wheel sensor 152, the angle-of-turn sensor 154, and the axle sensor 156 mentioned above, various sensors that are mounted in the work vehicle 100 may be included in the sensor group 150. For example, the sensor group 150 may include one or more sensors selected from among a temperature sensor, an illuminance sensor, a fuel sensor, a water temperature sensor, an oil level gauge, an engine revolution sensor, a vehicle speed sensor, a battery voltage sensor, a shuttle sensor, a hand accelerator sensor, an accelerator pedal sensor, a main shift lever sensor, a range shift lever sensor, a seat belt sensor, a PM sensor, an acceleration sensor, an angular velocity sensor, an IMU (Inertial Measurement Unit), and a geomagnetic sensor. The sensor group 150 may include a PTO sensor to detect rotation ON/OFF of the PTO shaft and/or a 3P position sensor to detect the position in the height direction (which hereinafter may be simply referred to as “height”) of the three-point hitch. Furthermore, in addition to or instead of one or more sensors mounted on the work vehicle 100, one or more sensors that are mounted on the implement 300 may be included in the sensor group 150 of the travel control system 1000.

In the example shown in FIG. 3A, the controller 180 includes a plurality of ECUs. These ECUs may include the ECUs 181 to 184 illustrated in FIG. 2, for example. However, the controller 180 may be a single ECU or other computer. FIG. 3B is a block diagram showing an example configuration for such a controller 180. In the example of FIG. 3B, the controller 180 includes a processor 281, a ROM (Read Only Memory) 283, a RAM (Random Access Memory) 285, a communicator 287, and a storage device 289. These component elements may be connected to one another via a bus 290.

The processor 281 is a semiconductor integrated circuit, also called a central processing unit (CPU) or a microprocessor. The processor 281 may include a graphics processing unit (GPU). The processor 281 consecutively executes a computer program describing predetermined instructions and being stored in the ROM 283, and achieves processes that are necessary for the travel control system according to the example embodiment of the present invention. The controller 180 may include a plurality of processors 281. The plurality of processors 281 may work in cooperation to perform the processes that are necessary for the travel control system according to the present example embodiment of the present invention. A portion or an entirety of the processor 281 may be an FPGA (Field Programmable Gate Array), an ASIC (Application Specific Integrated Circuit), or an ASSP (Application Specific Standard Product) incorporating a CPU.

The communicator 287 is an interface to perform data communications between the controller 180 and an external computer. The communicator 287 is capable of wired communications via a CAN (Controller Area Network) or the like, or wireless communications compliant with the Bluetooth (registered trademark) standards and/or the Wi-Fi (registered trademark) standards.

The storage device 289 can store position data acquired from the positioning device 110, sensor data acquired from the sensor group 150, position data and/or sensor data in the middle of processing, data of first information acquired from the position data and second information acquired from the sensor data, and the like. The storage device 289 includes a hard disk drive or a non-volatile semiconductor memory, for example. In this example, the storage device 289 may serve as the storage device 870 in the example of FIG. 3A.

The hardware configuration of the controller 180 is not limited to the above example. It is not necessary for a portion or an entirety of the controller 180 to be mounted in the work vehicle 100. By utilizing the communicator 287, a computer or computers located outside the work vehicle 100 may be allowed to function as a portion or an entirety of the controller 180. For example, a computer or computers included in a server computer(s) and/or a terminal device(s) that is connected to a network may function as a portion or an entirety of the controller 180. On the other hand, a computer or computers that is mounted in the work vehicle 100 may perform all functions required of the controller 180.

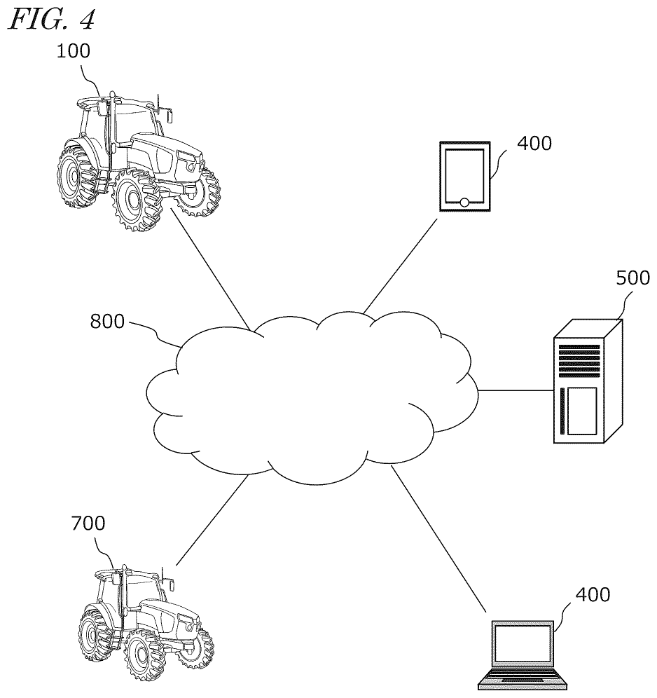

FIG. 4 is a schematic diagram showing another example configuration for a travel control system according to an example embodiment of the present invention. The system shown in FIG. 4 includes the work vehicle 100, another work vehicle 700, a server computer 500, and a plurality of terminal devices 400. The terminal devices 400 may be either mobile or stationary terminal devices. A portion or an entirety of the functionality of the controller 180 shown in FIG. 3B may be realized by one or more computers that are connected to the communicator 287 of the controller 180 of the work vehicle 100 via a communications network 800. Such a computer(s) may be the server computer 500 or the terminal device(s) 400. This communications network 800 may have the other work vehicle (e.g., agricultural machine) 700 connected thereto. Communication may be performed between the controller 180 of the work vehicle 100 and the other work vehicle 700. Via the communications network 800, a portion of the data to be used for the processing by the controller 180 of the work vehicle 100 may be supplied from the other work vehicle 700 to the controller 180. For example, waypoint data defining a path and a series of operations as generated by the controller of the other work vehicle 700 may be transmitted from the other work vehicle 700 to the controller 180 of the work vehicle 100. Based on the waypoint data, the controller 180 can perform a playback operation in a reproducing mode as will be described below.

As shown in FIG. 3B, an example of the “controller” in an example embodiment of the present invention is a computer that includes at least one processor and at least one memory storing a computer program (code) defining control processes to be executed by the processor. The “controller” may be a computer equipped with an FPGA (Field-Programmable Gate Array), an ASSP (Application Specific Standard Product), an ASIC (Application-Specific Integrated Circuit), or other hardware accelerators configured to execute the control processes.

A “processor” in an example embodiment of the present invention is a hardware electronic circuit such as a CPU (Central Processing Unit), a GPU (Graphics Processing Unit), a DSP (Digital Signal Processor), an ISP (Image Signal Processor), or an NPU (Neural Network Processing Unit). A “memory” is a hardware electronic circuit such as a ROM (Read Only Memory) or a RAM (Random Access Memory). A portion of the memory may be a storage medium that is connected to the processor via interconnects or a network. These hardware electronic circuits may be implemented by one or more integrated circuits (IC) or large-scale integrated circuits (LSI). Each functional unit or block and its associated components within the electronic circuit may be individually manufactured as an individual integrated circuit chip, or a portion or an entirety of these functional units or blocks may be combined so as to be manufactured as a single integrated circuit chip.

A program defining the operation of a processor is designed so that the processor will execute one or more functions, manipulations, steps, or process according to an example embodiment of the present invention.

As will be described below, the travel control system 1000 is capable of controlling the operation of the work vehicle 100 by using a so-called teaching-playback method, which is used in the fields of robot control. The controller 180 of the travel control system 1000 can be configured or programmed to operate in a recording mode and a reproducing mode. The recording mode is a mode in which multiple positions (hereinafter also referred to as “waypoints”) defining a path that has been traveled by the work vehicle 100 are recorded. In the recording mode, operations of the work vehicle 100 at the respective waypoints may further be recorded. The reproducing mode is a mode in which the travel path of the work vehicle 100 is reproduced based on the position data of the work vehicle 100 that was recorded in the recording mode. If operations of the work vehicle 100 at the respective waypoints were recorded in the recording mode, the operations of the work vehicle 100 at the respective waypoints may also be reproduced in the reproducing mode. The operations in the recording mode and the reproducing mode correspond to, respectively, an operation of teaching and an operation of playback in the teaching-playback method. The operations of the controller 180 in the recording mode and the reproducing mode may be referred to as “teaching” and “playback”, respectively. The recording mode may be referred to as the “teaching mode”, and the reproducing mode as the “playback mode”.

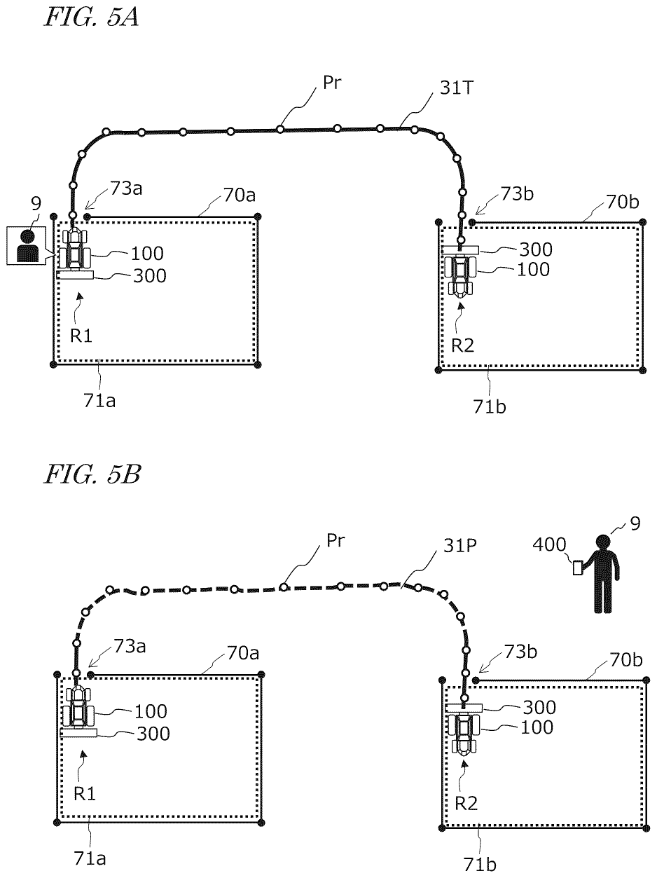

With reference to FIG. 5A and FIG. 5B, operations of the controller 180 of the travel control system 1000 in the recording mode and the reproducing mode will be described. FIG. 5A is a diagram schematically showing an example of a path 31T that is traveled by the work vehicle 100 in the recording mode. FIG. 5B is a diagram schematically showing an example of a path 31P that is traveled by the work vehicle 100 in the reproducing mode. In this example, the path 31T and the path 31P are paths that connect a first field 70a and a second field 70b.

As shown in FIG. 5A, in the recording mode, the work vehicle 100 travels along the path 31T from a position R1 in the first field 70a to a position R2 in the second field 70b. In the recording mode, the controller 180 records the position data being output from the positioning device 110, as acquired while the work vehicle 100 travels along the path 31T, to the storage device 870.

FIG. 5A shows a state where the work vehicle 100 is located at a start point (position R1) of the path 31T and a state where the work vehicle 100 is located at an end point (position R2). In this example, the path 31T is a path that begins at the position R1 in the first field 70a, goes out of the first field 70a through an entrance/exit 73a of the first field 70a, goes outside the field, goes into the second field 70b through an entrance/exit 73b of the second field 70b, and ends at the position R2 in the second field 70b. The position R1 in the first field 70a is located in a predetermined region 71a within the first field 70a, for example. The position R2 in the second field 70b is located in a predetermined region 71b within the second field 70b, for example.

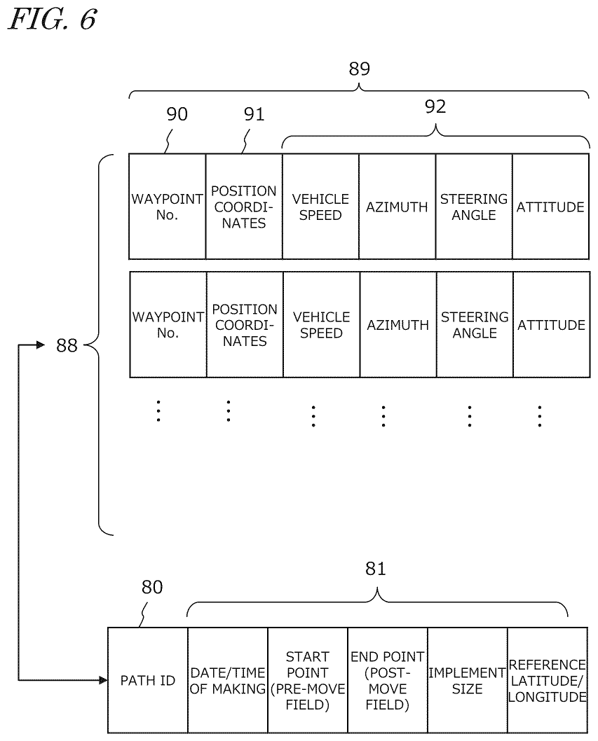

In the recording mode, while the work vehicle 100 is traveling along the path 31T, for example, the controller 180, based on the position data that is output from the positioning device 110, records multiple pieces of waypoint data to the storage device 870. Each of the multiple pieces of waypoint data includes information concerning the position of the work vehicle 100 (which may be referred to as “first information”). For example, as shown in FIG. 5A, position data indicating each of a plurality of positions (waypoints) Pr on the path 31T along which the work vehicle 100 travels is recorded to the storage device 870 as waypoint data. As “path data” indicating the path 31T, the multiple pieces of waypoint data may be recorded to the storage device 870 in association with information of the path 31T. A specific example will be described with reference to FIG. 6.

In the recording mode, the controller 180 may further record sensor data concerning the state of the work vehicle 100 that is output from the sensor group 150 to the storage device 870. In such a case, for example, each of the multiple pieces of waypoint data further includes information concerning the state of the work vehicle 100 (which may be referred to as “second information”). The second information included in each of the multiple pieces of waypoint data may be recorded in association with the corresponding first information. Because the second information is recorded in association with the corresponding first information, information of the state of the work vehicle 100 at each position on the path 31T along which the work vehicle 100 has traveled is recorded.

FIG. 6 is a schematic diagram showing an example of waypoint data to be recorded to the storage device 870. Each piece of waypoint data 89 shown in FIG. 6 includes a waypoint number (No.) 90, first information 91 indicating the position of the work vehicle 100, and second information 92 indicating state of the work vehicle 100. The first information 91 indicates position coordinates of that waypoint. The position coordinates may indicate a latitude and a longitude in the geographical coordinate system, or indicate position coordinates in a coordinate system that is distinct from the geographical coordinate system, for example. In addition to the latitude and longitude, the position coordinates may also include altitude information. The second information 92 in the example of FIG. 6 includes information indicating the vehicle speed, azimuth, steering angle, attitude of the work vehicle 100. However, the second information 92 may include only some of such information. Alternatively, the second information 92 may include other information not shown in FIG. 6. As described above, the waypoint data may not even include the second information 92. Path data 88 including an aggregate of waypoint data 89 (i.e., multiple pieces of waypoint data) may be recorded to the storage device 870 in association with an identifier (e.g., path ID) 80 identifying a path. The identifier 80 of a path is kept in association with information 81 concerning that path. In the illustrated example, the information 81 concerning the path includes information of date/time of making the path data, information of a start point (e.g. a pre-move field) of the path, information of an end point (e.g. a post-move field) of the path, information of the latitude and longitude of a reference point (e.g., a start point or an end point of the path) of the path, and information of the size of an implement that was linked to the work vehicle when traveling along the path, for example. The information 81 concerning the path may include only some of such information. Alternatively, the information 81 concerning the path may include other information that is not illustrated in FIG. 6.

The second information broadly includes information concerning states of the work vehicle 100 other than its position. The second information includes information concerning operation of the work vehicle 100, e.g., a traveling state, for example. The traveling state of the work vehicle 100 is defined by the velocity, acceleration (i.e., rate of change in velocity per unit time), traveling direction (azimuth), and the like of the work vehicle 100. Information concerning the traveling state of the work vehicle 100 includes any one or more of: information of the velocity of the work vehicle 100, information of the engine speed of the work vehicle 100, information of the acceleration of the work vehicle 100; information of the azimuth (orientation) of the work vehicle 100, information of the steering angle of the wheels responsible for steering of the work vehicle 100, information of the gear ratio of the transmission 103 of the work vehicle 100, and the like, for example. The second information may include information of the attitude of the work vehicle 100. Information of the azimuth of the work vehicle 100 may include information of an angle made by the horizontal component of the traveling direction of the work vehicle 100 and a reference direction (e.g., north), for example. Information of the attitude of the work vehicle 100 may include information of the roll angle and pitch angle of the work vehicle 100, for example. Information of the attitude of the work vehicle 100 includes information of the azimuth of the work vehicle 100, for example. Without being limited to information concerning the operation of the work vehicle 100, the second information may include information of the temperature of the work vehicle 100 (e.g., temperature of the engine coolant), information concerning the presence/absence of problems of the work vehicle 100 (e.g., Diagnostic Trouble Code: DTC), and the like, for example. Specific examples of methods of acquiring the second information will be described later.

The second information may include information concerning the state of the linkage device 108 to enable linking of the implement 300. The linkage device 108 may include the PTO shaft to supply motive power to the implement 300 and a three-point hitch to adjust the height of the implement 300, for example. Information concerning the state of the linkage device 108 may include any one or more of: information of rotation ON or OFF of the PTO shaft, and information of the height of the three-point hitch, for example.

In a case where the work vehicle 100 has the implement 300 linked thereto, the second information may include, in addition to information concerning the state of the work vehicle 100, information concerning the state of the implement 300. For example, in a case where the implement 300 has a positioning device mounted thereto, information of the position or azimuth (e.g., angle with respect to a reference azimuth) of the implement 300 may be included in the second information. Alternatively, in a case where a sensor to detect the operation of a movable structure in the implement 300 is provided in the implement 300, information that is detected by that sensor may be included in the second information.

In the example of FIG. 5A, in the recording mode, the work vehicle 100 performs manual traveling via manual operation of the driver 9 on the work vehicle 100. Without being limited to this example, however, the work vehicle 100 may perform self-traveling via self-driving in the recording mode. When the work vehicle 100 performs self-traveling in the recording mode, the work vehicle 100 may autonomously travel without involving manual operation of the driver, or perform self-traveling but travel partly based on manual operation of the driver. For example, an automatic steering control may be performed during travel in the recording mode, such that the driver performs control of the traveling speed of the work vehicle 100 while steering control is automatically performed. Alternatively, during travel in the recording mode, the work vehicle 100 may perform self-traveling, while the implement 300 operates via manual operation of the driver. Manual operation of the driver includes not only manual operation of the driver on the work vehicle 100, but also remote manipulation by a driver (operator) outside the work vehicle 100. Such remote manipulations may be performed by using the terminal devices 400 shown in FIG. 4, or other remote manipulation devices, for example.

In the reproducing mode shown in FIG. 5B, the work vehicle 100 performs travel via self-driving. In the reproducing mode, by controlling the speed and steering of the work vehicle 100 based on the position data recorded in the storage device 870, the controller 180 causes the work vehicle 100 to travel via self-traveling. In the reproducing mode, for example, the controller 180 causes the work vehicle 100 to travel along a target path 31P that is defined by the first information included in the multiple pieces of waypoint data recorded in the storage device 870. For example, the controller 180 performs steering control for the work vehicle 100 so as to minimize deviations of the position and orientation (azimuth) of the work vehicle 100 with respect to the target path 31P. This allows the work vehicle 100 to travel along the target path 31P. In the reproducing mode, the work vehicle 100 is able to automatically reproduce the path of the work vehicle 100 that was recorded in the recording mode.

In the reproducing mode, as shown in FIG. 5B, a driver (user) 9 who is at a remote position from the work vehicle 100 may operate the terminal device 400 to control the self-traveling of the work vehicle 100. Without being limited to the illustrated example, a driver who operates the terminal device or the operation terminal may be on the work vehicle 100. The terminal device 400 to be manipulated by the driver 9 may be a mobile type operation terminal that can be carried around, or a stationary type operation terminal. A stationary type operation terminal may be attached to the work vehicle 100, or provided at a remote place from the work vehicle 100. The terminal device 400 may include a display device, e.g., a touch screen. For example, the display device may be liquid crystal, organic light-emitting diode (OLED), or other displays. The terminal device 400 may further include one or more buttons. The terminal device 400 may include a storage device.

With the travel control system according to the present example embodiment, in the reproducing mode, the operation (e.g., travel) of the work vehicle 100 can be automatically reproduced based on first information concerning the position of the work vehicle 100 that was recorded in the storage device 870. As a result, iterative operations of the work vehicle 100 can be efficiently performed. Therefore, automation and unmanned execution of the operation of the work vehicle 100 can be promoted.

In the recording mode, by further recording second information concerning the state of the work vehicle 100 other than its position in association with the first information concerning the position of the work vehicle 100, automation and unmanned execution of the operation of the work vehicle 100 can be further promoted.

As in the examples of FIG. 5A and FIG. 5B, in a case where the work vehicle 100 has the implement 300 linked thereto, based on the first information (or, alternatively, the first information and second information) included in multiple pieces of waypoint data recorded in the recording mode, the controller 180 can control the operations of the work vehicle 100 and the implement 300, while causing the work vehicle 100 to perform self-traveling. In other words, in the reproducing mode, the work vehicle 100 can automatically reproduce not only the operation of the work vehicle 100 that was recorded in the recording mode, but also the operation of the implement 300.

In a case where the work vehicle 100 has the implement 300 linked thereto, based on the first information recorded in the recording mode, the operation of the work vehicle 100 with the implement 300 linked thereto can be reproduced in the reproducing mode, such that iterative operations of the work vehicle 100 with the implement 300 linked thereto can be efficiently carried out. For example, by recording second information concerning the state of the implement 300 in association with the first information concerning the position of the work vehicle 100 in the recording mode, automation and unmanned execution of the work by the implement 300 can be promoted. In other words, the work vehicle 100 may automatically reproduce not only the operation of the work vehicle 100 recorded in the recording mode but also the operation of the implement 300, such that iterative work to be performed by the implement 300 can be efficiently performed.

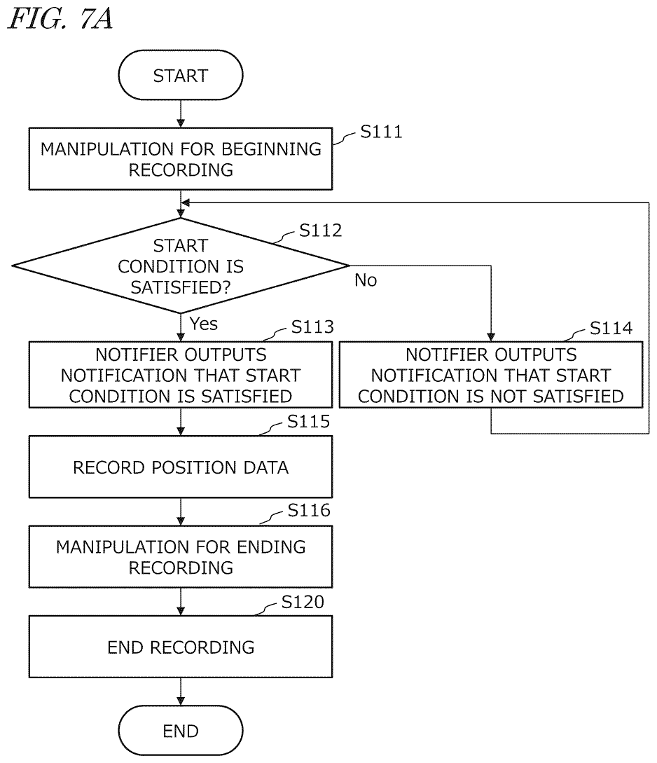

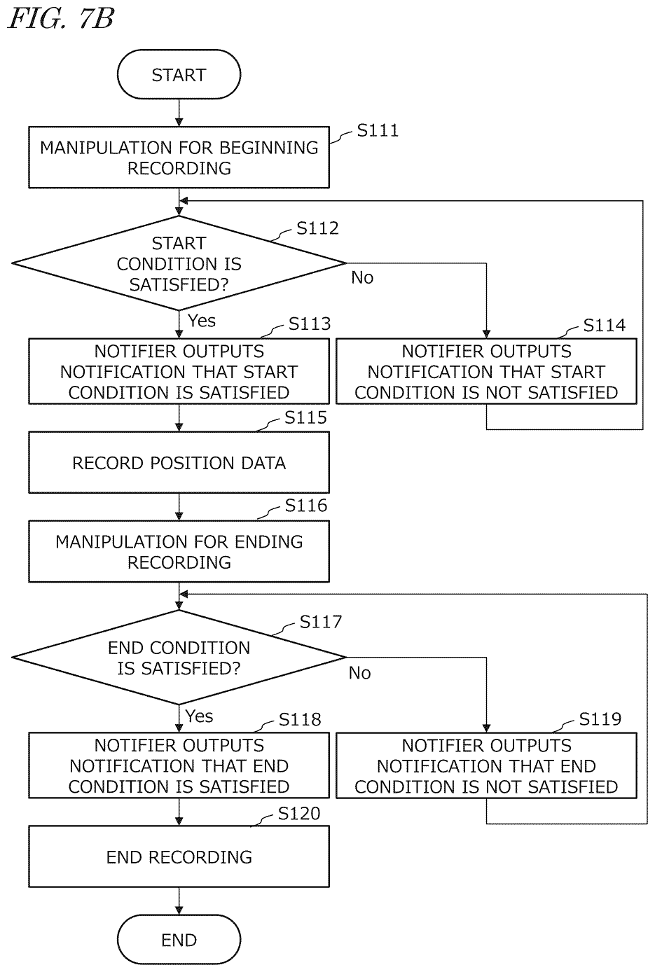

FIG. 7A is a flowchart showing an example processing to be performed in the recording mode.

At step S111, the controller 180 receives a signal including an instruction to begin recording of position data. For instance, when a manipulation for beginning recording of position data is performed by, for example, the user (e.g., a driver of the work vehicle 100), the controller 180 receives a signal including an instruction to begin recording of position data. For instance, the user performs the manipulation for beginning recording of position data by manipulating an input device such as the operation terminal 200 or a predetermined operation switch provided in the work vehicle 100. The “manipulation for beginning recording of position data” may be performed when beginning recording of position data at the start point of a path to be recorded in the recording mode, for example. Without being limited to this, it may be performed when, after recording of position data is suspended in the middle of a path to be recorded in the recording mode, the recording of position data is to be restarted.

At step S112, the controller 180 determines whether a condition for beginning recording of position data (which may be referred to as the “start condition” or “recording start condition”) is satisfied or not. The recording start condition stipulates satisfying all of a plurality of predefined conditions. In other words, the controller 180 determines whether all of the plurality of conditions are satisfied or not. If it is determined that the recording start condition is satisfied (“Yes” from step S112), control proceeds to step S113. If it is determined that the recording start condition is not satisfied (“No” from step S112), control proceeds to step S114.

The plurality of conditions defining the recording start condition may include any two or more of the following conditions, for example. Details of each condition and a method of determination thereof will be described later. However, the conditions defining the recording start condition are not limited to what is exemplified below.
the work vehicle 100 is stopped
the prime mover 102 of the work vehicle 100 is working
roll angle of the work vehicle 100 has a predetermined value or below
pitch angle of the work vehicle 100 has a predetermined value or below
reception of satellite signals by the positioning device 110 is sufficient
the work vehicle 100 is in a predetermined traveling mode
the work vehicle 100 is in a predetermined region
rotation of the PTO shaft in the linkage device 108 of the work vehicle 100 is OFF
height of the three-point hitch in the linkage device 108 of the work vehicle 100 has a predetermined value or above

At step S113, the controller 180 causes a notification that the recording start condition is satisfied (which may be referred to as a “first notification”) to be output by a notifier. At step S114, the controller 180 causes a notification that the recording start condition is not satisfied to be output by a notifier.

The notifier may include a display device and/or an audio output device such as a buzzer or loudspeaker, for example. The notifier is provided in an operation terminal that is operated by the user (e.g., the operation terminal 200 included in the work vehicle 100), for example. The notifier may be mounted in the work vehicle 100, and is not limited to this example so long as it is configured to be capable of outputting a notification toward the user. The notification may be issued in any manner that stimulates the senses of the user, e.g., an image, light, sound, or vibration. A combination of any one or more of image, light, sound, and vibration may be used as a notification. Depending on whether the recording start condition is satisfied or not satisfied, the controller 180 causes a respectively different notification to be output by the notifier. For example, if the notifier includes a display device, a respectively different image is displayed on the display device depending on whether the recording start condition is satisfied or not satisfied. If the notification includes light or vibration, the flickering pattern (cycle) of light or vibration pattern (cycle) may be varied depending on whether the recording start condition is satisfied or not satisfied.

Because the controller 180 causes the notifier to output a notification as to whether the recording start condition is satisfied or not, it becomes possible to restrain recording of position data from being performed in a state that is not suitable for recording position data. Therefore, reproducibility of the operation of the work vehicle 100 in the reproducing mode can be enhanced, and self-traveling of the work vehicle 100 in the reproducing mode can be smoothly performed. This can also reduce the likelihood that recording of position data may be suspended halfway, in the middle of the recording mode. In a situation where recording of position data happens to be suspended in the middle of the recording mode, this can solve the problem of having to perform the travel under the recording mode all over again, thus providing an improved convenience for the user.

At step S114, the controller 180 may cause a notification indicating any condition among the plurality of conditions that is unsatisfied (which may be referred to as a “second notification”) to be output by the notifier. The controller 180 may cause a notification indicating a manipulation to be performed in order to satisfy any condition among the plurality of conditions that is unsatisfied (which may be referred to as a “third notification”) to be output by the notifier. If the notifier includes a display device, for example, the second notification and/or the third notification may be indicated to the user as an image(s). If the notifier includes an audio output device, the second notification and/or the third notification may be indicated to the user as an audio(s). If the notifier includes a display device, after displaying the second notification and/or the third notification on the display device, the second notification and/or the third notification being displayed may be erased when the unsatisfied condition becomes satisfied. Because the recording start condition stipulates that all of the plurality of conditions are satisfied, causing the notifier to output the second notification and/or the third notification provides an improved convenience for the user. For example, this makes it easier for the user to know what action is necessary in order to satisfy the recording start condition.

In the case of proceeding to step S114, after the lapse of a predetermined time, for example, the controller 180 performs the determination of step S112 again.

In the case of proceeding to step S113, at step S115 following step S113, the controller 180 performs recording of position data as the work vehicle 100 travels. For example, the controller 180 may record position data every time the work vehicle 100 travels a certain distance, or for every certain period of time. The certain distance (e.g., a distance between two adjacent waypoints Pr along the traveling direction of the work vehicle 100 in the example of FIG. 5A) may be set to a value on the order of several ten centimeters (cm) to several meters (m), for example. The certain period of time may be set to a value in the range from 1 second to 10 seconds, for example. Note that the recording of position data at step S115 includes not only recording position data that is output from the positioning device 110 to the storage device 870 but also temporarily storing to a storage device that is distinct from the storage device 870. The storage device that is distinct from the storage device 870 may be a memory included in the controller 180, such as the RAM 285 shown in e.g. FIG. 3B, or a storage device that is included in a server computer connected to the controller 180 via a communications network.

After step S115, the controller 180 receives a signal including an instruction to end recording of position data at step S116. For instance, when a manipulation for ending recording of position data is performed by e.g. the user, the controller 180 receives a signal including an instruction to end recording of position data.

After step S116, the controller 180 ends recording of position data at step S120.

FIG. 7B is a flowchart showing another example processing to be performed by the controller 180 in the recording mode. The flowchart of FIG. 7B differs from the flowchart of FIG. 7A in that steps S117, S118 and S119 are further included. Differences from the flowchart of FIG. 7A will mainly be described.

The processes of steps S111 to S116 are performed similarly to the example of FIG. 7A.

After step S116, the controller 180 determines at step S117 whether a condition for ending recording of position data (which may be referred to as the “end condition” or “recording end condition”) is satisfied or not. The recording end condition stipulates satisfying all of a plurality of predefined conditions. In other words, the controller 180 determines whether all of the plurality of conditions are satisfied or not. If it is determined that the recording end condition is satisfied (“Yes” from step S117), control proceeds to step S118. If it is determined that the recording end condition is not satisfied (“No” from step S117), control proceeds to step S119.

The plurality of conditions defining the recording end condition may include any two or more of the aforementioned exemplary conditions defining the recording start condition, for example. The recording end condition and the recording start condition may be similar.

At step S118, the controller 180 causes a notification that the recording end condition is satisfied (which may be referred to as a “fourth notification”) to be output by a notifier. At step S119, the controller 180 causes a notification that the recording end condition is not satisfied to be output by the notifier. The notifier to output the notifications at step S118 and step S119 may be the same notifier that outputs the notification as to whether the recording start condition is satisfied or not at step S113 or step S114, or a different notifier.

Because the controller 180 causes the notifier to output a notification as to whether the recording end condition is satisfied or not, it becomes possible to restrain recording of position data from being ended in a state that is not suitable for ending recording of position data. Therefore, reproducibility of the operation of the work vehicle 100 in the reproducing mode can be enhanced, and self-traveling of the work vehicle 100 in the reproducing mode can be smoothly performed.

At step S119, the controller 180 may cause the notifier to output a notification indicating any condition among the plurality of conditions that is unsatisfied (which may be referred to as a “fifth notification”). The controller 180 may causes the notifier to output a notification indicating a manipulation to be performed in order to satisfy any condition among the plurality of conditions that is unsatisfied (which may be referred to as a “sixth notification”). If the notifier includes a display device, for example, the fifth notification and/or the sixth notification may be indicated to the user as an image(s). If the notifier includes an audio output device, the fifth notification and/or the sixth notification may be indicated to the user as an audio(s). If the notifier includes a display device, after displaying the fifth notification and/or the sixth notification on the display device, the fifth notification and/or the sixth notification being displayed may be erased when the unsatisfied condition becomes satisfied. Because the recording end condition stipulates that all of the plurality of conditions are satisfied, causing the notifier to output the fifth notification and/or the sixth notification provides an improved convenience for the user. For example, this makes it easier for the user to know what action is necessary in order to satisfy the recording end condition.

In the case of proceeding to step S119, after the lapse of a predetermined time, for example, the controller 180 performs the determination of step S117 again.

In the case of proceeding to step S118, at step S120 following step S118, the controller 180 ends recording of position data.

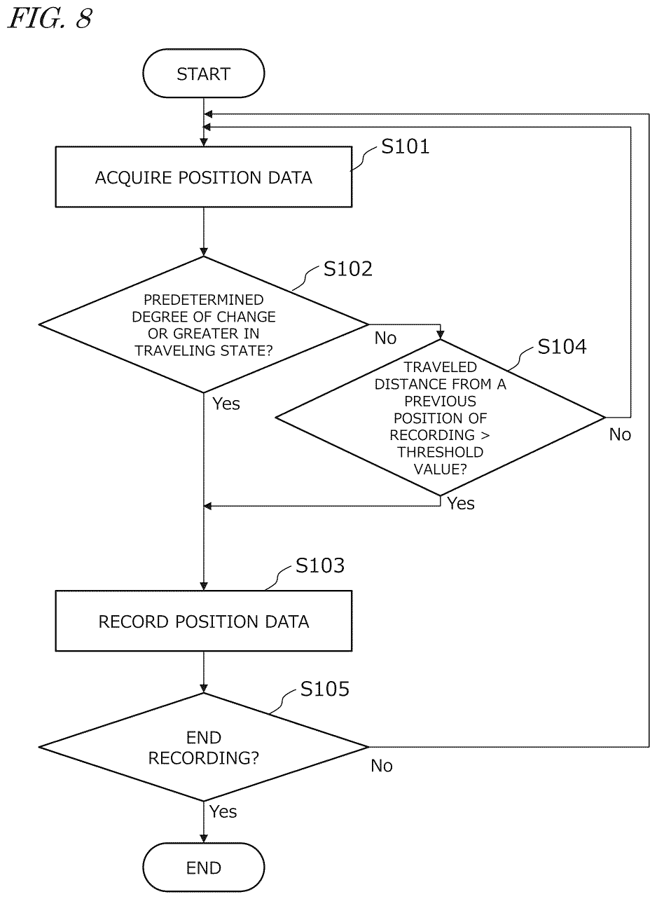

FIG. 8 is a flowchart showing an example processing to be performed by the controller 180 in the recording mode. FIG. 8 is a flowchart showing an example of the process to be performed at step S115 n FIG. 7A or FIG. 7B.

The timing of beginning the recording mode is designated by the user, for example. For instance, the controller 180 may begin the recording mode when a signal including an instruction to begin the recording mode is transmitted to the controller 180 through a manipulation of the driver. For instance, the driver on the work vehicle 100 can transmit a signal including an instruction to begin the recording mode to the controller 180 by manipulating an input device such as the operation terminal 200 or a predetermined operation switch provided in the work vehicle 100. The recording mode may be begun during travel of the work vehicle 100, or begun while the work vehicle 100 is stopped.

Once the recording mode is begun, then at step S101, the controller 180 acquires position data that is output from the positioning device 110. For example, the controller 180 may acquire position data each time a certain period passes, or each time the work vehicle 100 travels a certain distance.

At step S102, the controller 180 determines whether a predetermined degree of change or greater has occurred in the traveling state of the work vehicle 100. As described earlier, the traveling state of the work vehicle 100 is defined by the velocity, acceleration, traveling direction (azimuth), or the like of the work vehicle 100. For example, if the change in any of the velocity, acceleration, and traveling direction (azimuth) of the work vehicle 100 registers a predetermined value or higher, it is determined that a predetermined degree of change or greater has occurred in the traveling state of the work vehicle 100 (“Yes” from step S102). For example, if the work vehicle 100 comes to a halt from a traveling state, or if the work vehicle 100 begins traveling from a halting state, etc., it is determined that a predetermined degree of change or greater has occurred in the traveling state of the work vehicle 100. If “Yes” at step S102, control proceeds to step S103. If “No” from step S102, control proceeds to step S104.

At step S103, the controller 180 records position data that was acquired in step S101. The recording of position data in step S103 includes not only recording the position data that is output from the positioning device 110 to the storage device 870, but also temporarily storing it to a storage device that is distinct from the storage device 870. Such a storage device distinct from the storage device 870 may be a memory included in the controller 180, e.g., the RAM 285 shown in FIG. 3B, or may be a storage device included in a server computer that is connected to the controller 180 via a communications network, for example.

At step S104, the controller 180 determines whether the traveled distance from a previous position of recording position data exceeds a threshold value or not. The threshold value for traveled distance may be set to a value on the order of several ten centimeters (cm) to several meters (m), for example. As another example, at step S104, the controller 180 may determine whether the elapsed time since the previous time of recording position data exceeds a threshold value or not. The time-wise threshold value may be set to a value in the range from 1 second to 10 seconds, for example.

If “Yes” at step S104, control proceeds to step S103. If “No” at step S104, recording of position data is not performed, and control returns to step S101.

Until receiving a signal including an instruction to end recording of position data (step S105), the controller 180 repeats the processes of step S101, step S102, step S103, and step S104.

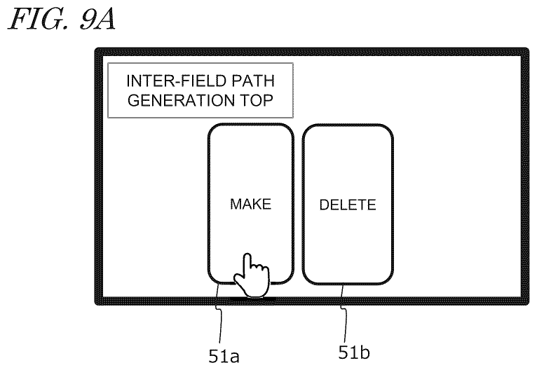

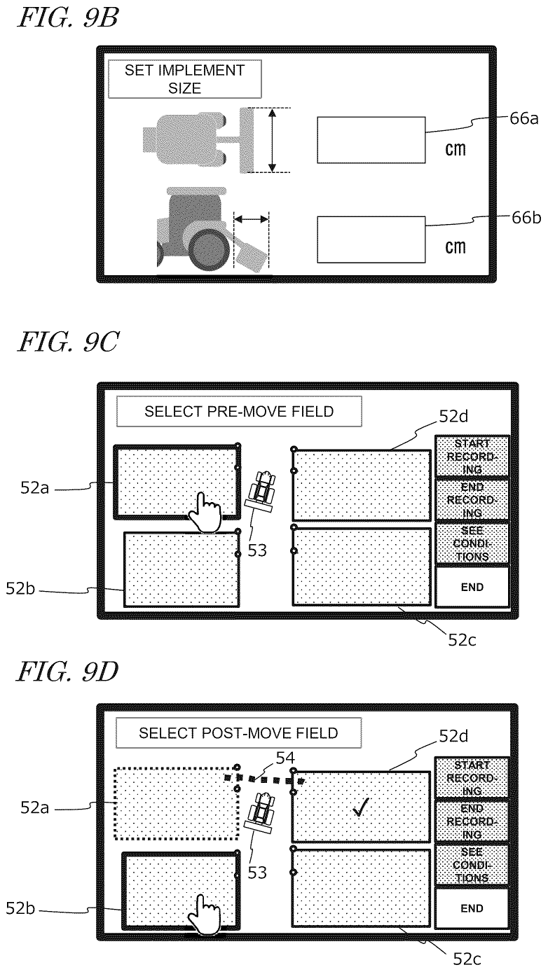

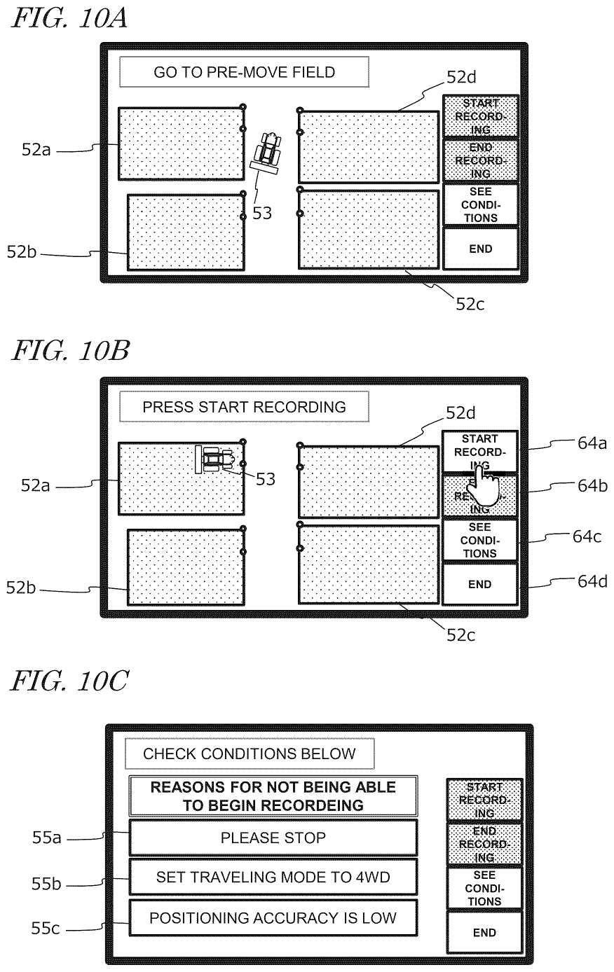

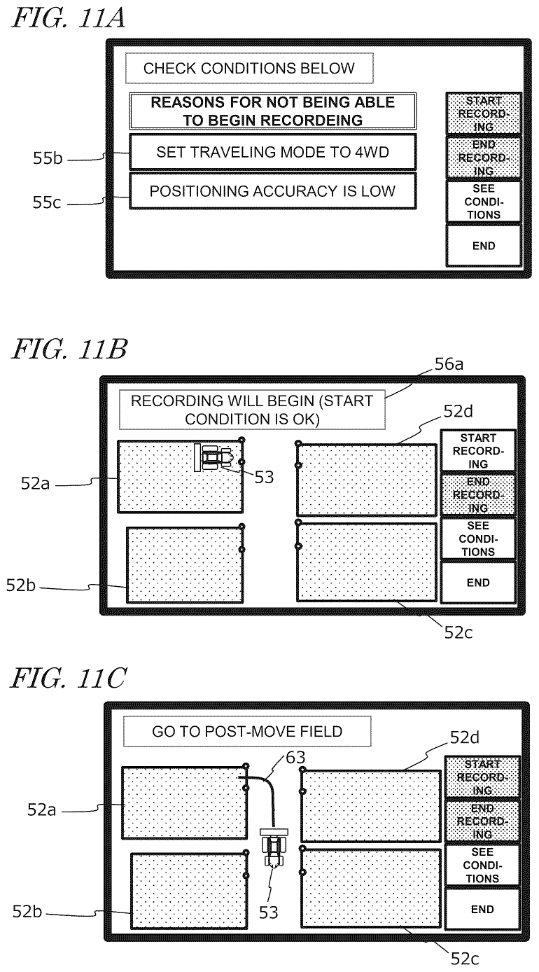

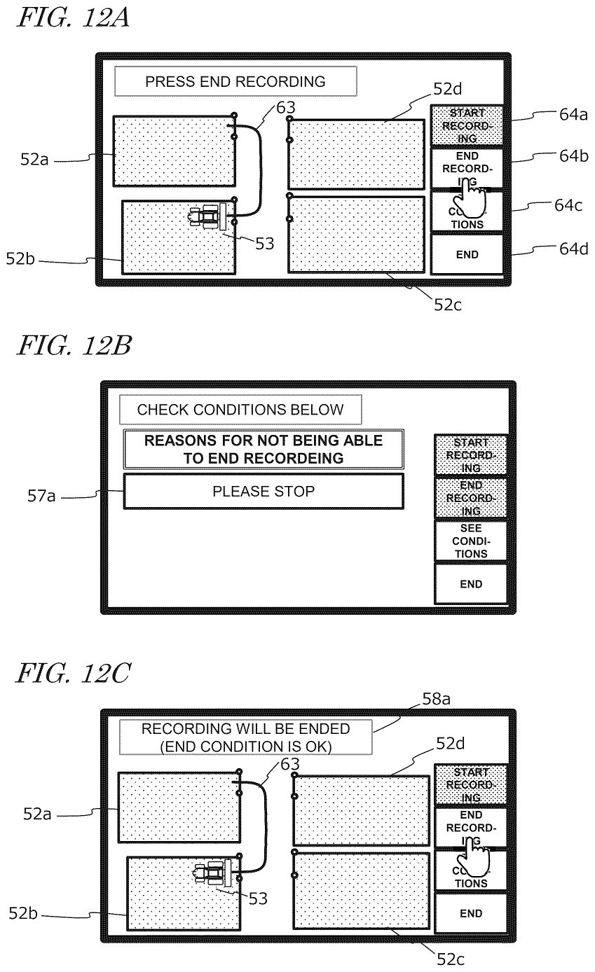

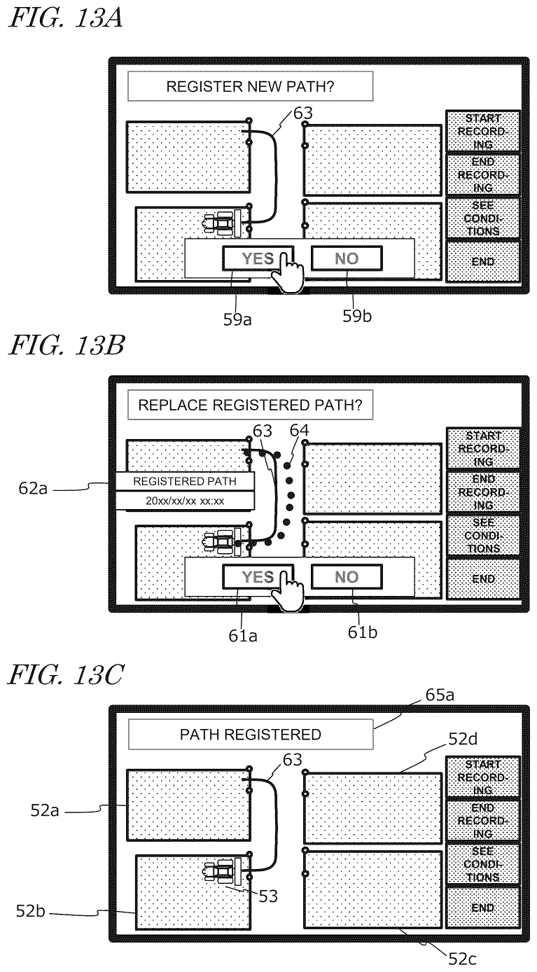

FIG. 9A to FIG. 9D, FIG. 10A to FIG. 10C, FIG. 11A to FIG. 11C, FIG. 12A to FIG. 12C, and FIG. 13A to FIG. 13C show examples of screen images to be displayed on an operation terminal that is operated by the user (e.g., a driver of the work vehicle 100). These screen images include a graphical user interface (GUI) which is a screen for allowing the user to make settings concerning the recording mode. These screen images are displayed on a display device that is included in the operation terminal 200 of the work vehicle 100, for example. Herein, an example is illustrated where position data is being recorded while the work vehicle 100 travels along a path interconnecting fields in the recording mode.

FIG. 9A, FIG. 9B, FIG. 9C, and FIG. 9D show example screen images to make settings for the recording mode before the work vehicle 100 begins travel under the recording mode. FIG. 10A, FIG. 10B, FIG. 10C, FIG. 11A, FIG. 11B, FIG. 11C, FIG. 12A, FIG. 12B, and FIG. 12C are example screen images to be displayed during the recording mode. FIG. 13A, FIG. 13B, and FIG. 13C are example screen images to be displayed after the work vehicle 100 finishes travel under the recording mode.

As shown in FIG. 9A, a screen image is displayed to select to either make or delete path data. In the screen image of FIG. 9A, the user may select a “MAKE” button 51a or a “DELETE” button 51b in accordance with the manipulation which the user wishes to perform. When newly generating path data, the “MAKE” button 51a is selected as in the illustrated example. If the “MAKE” button 51a is selected in the screen image of FIG. 9A, a transition occurs to the screen image of FIG. 9B or FIG. 9C.

The screen image of FIG. 9B includes a GUI which allows the user to set a size of the implement 300. In the illustrated example, the user is able to input a width and a length of the implement 300, respectively, in boxes 66a and 66b. The GUI may be configured so that it allows not only the width and length of the implement 300 but also other information concerning work to be input. For example, the GUI may be configured so that it allows at least one of the following to be input: type of work; type of the implement (e.g., model); or maximum height when the implement is lifted.

The screen image of FIG. 9C includes a GUI which allows the user to set a pre-move field. In the illustrated example, the user selects a pre-move field from among field images 52a, 52b, 52c and 52d that are being displayed (which may be just referred to as “fields 52a to 52d” for simplicity). In the screen image, an image 53 representing the work vehicle 100 is also shown. The image 53 representing the work vehicle 100 may be indicated at a position reflecting the current position of the work vehicle 100. This allows the user to confirm a position relationship between the work vehicle 100 and the fields within the screen image. In the example of FIG. 9C, the field 52a is selected as a pre-move field. Once a pre-move field is selected, a transition occurs to the screen image of the FIG. 9D.

The screen image of FIG. 9D includes a GUI which allows the user to set a post-move field. In the illustrated example, the user selects a post-move field from among fields which are not the pre-move field 52a, i.e., the fields 52b, 52c and 52d. The illustrated example includes an indication that path data concerning a path 54 connecting the selected pre-move field 52a and the field 52d is already recorded. In the example of FIG. 9D, the field 52b is being selected as a post-move field.

The screen image of FIG. 10A may be displayed until the work vehicle 100 moves to the pre-move field 52a. After the work vehicle 100 has moved to the pre-move field 52a, a transition occurs to the screen image of FIG. 10B.

The screen image of FIG. 10B includes a GUI which allows the user to perform a manipulation for beginning recording of position data. In the screen image of FIG. 10B, the user selects the “START RECORDING” button 64a to perform a manipulation for beginning recording of position data. If it is determined that the recording start condition is not satisfied, a transition occurs to the screen image of the FIG. 10C. If it is determined that the recording start condition is satisfied, a transition occurs to the screen image of the FIG. 11B.

The screen image of FIG. 10C includes notifications 55a, 55b and 55c indicating conditions among the plurality of conditions defining the recording start condition that are unsatisfied. The notifications 55a, 55b and 55c respectively correspond to the condition that “the work vehicle 100 is stopped”, the condition that “the work vehicle 100 is in a predetermined traveling mode”, and the condition that “reception of satellite signals by the positioning device 110 is sufficient”. Upon is determining that any of these conditions has become satisfied, the notification corresponding to the now-satisfied condition is erased. For example, the screen image of FIG. 11A may be displayed when, after the screen image of FIG. 10C is displayed, the work vehicle 100 comes to a halt so that the condition that “the work vehicle 100 is stopped” becomes satisfied. In the screen image of FIG. 11A, the notification 55a has been erased from the screen image of FIG. 10C.

The screen image of FIG. 11B includes a notification 56a indicating that the recording start condition is now satisfied.

If it is determined that the recording start condition is satisfied, a transition occurs to the screen image of FIG. 11C. The screen image of FIG. 11C may be displayed while position data is being recorded. The screen image of FIG. 11C includes the image 53 of the work vehicle 100 and a trajectory 63 of the work vehicle 100.

The screen image of FIG. 12A may be displayed after the work vehicle 100 has arrived at the post-move field, for example. The screen image of FIG. 12A includes a GUI which allows the user to perform a manipulation for ending recording of position data. In the screen image of FIG. 12A, the user selects an “END RECORDING” button 64b to perform a manipulation for ending recording of position data. If it is determined that the recording end condition is not satisfied, a transition occurs to screen image of the FIG. 12B. If it is determined that the recording end condition is satisfied, a transition occurs to screen image of the FIG. 12C.

The screen image of FIG. 12B includes a notification 57a indicating a condition among the plurality of conditions defining the recording end condition that is unsatisfied. The notification 57a corresponds to the condition that “the work vehicle 100 is stopped”. If it is determined that any unsatisfied condition has become satisfied, the notification corresponding to the now-satisfied condition is erased.

The screen image of FIG. 12C includes a notification 58a indicating that the recording end condition is now satisfied.

If it is determined that the recording end condition is satisfied, the screen images of FIG. 13A, FIG. 13B, and FIG. 13C may be displayed.

The screen image of FIG. 13A includes a GUI which allows the user to perform a manipulation to make a setting as to whether any acquired position data is to be recorded as path data to the storage device 870 or not. The user selects a “YES” button 59a or a “NO” button 59b to set whether the acquired position data is to be recorded as path data to the storage device 870 or not. In this example, while the work vehicle 100 is traveling, position data that is acquired from the positioning device 110 is temporarily stored in the storage device 870 or a storage device that is distinct from the storage device 870 (e.g. the RAM 285 shown in FIG. 3B or any other memory), and when the user selects the “YES” button 59a in the screen image of FIG. 13A, it is recorded to the storage device 870 as path data, in association with a path identifier and path information.

In a case where, as in the screen image of FIG. 13B, path data of a path connecting the pre-move field 52a and the post-move field 52b is already recorded in the storage device 870, a screen to make a setting as to whether path data is to be updated or not may be displayed. The user selects a “YES” button 61a or a “NO” button 61b to make a setting as to whether the path data is to be updated (replaced) or not. For the same combination of a pre-move field and a post-move field, more than one piece of path data may be recorded to the storage device 870. In the screen image of FIG. 13B, a path 64 that is already recorded in the storage device 870 and information 62a concerning the path 64 may also be displayed.

If path data is recorded in the storage device 870, the screen image of the FIG. 13C may be displayed. The screen image of the FIG. 13C includes a notification 65a that path data has been recorded in the storage device 870.

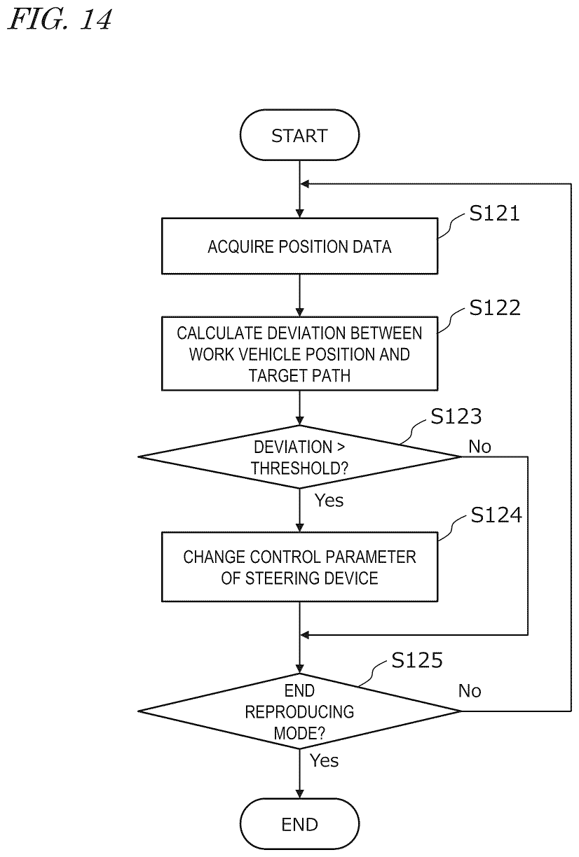

FIG. 14 is a flowchart showing an example processing to be performed in the reproducing mode.

In the reproducing mode, based on previously recorded waypoint data, the controller 180 causes the work vehicle 100 to automatically travel. The controller 180 acquires position data indicating the position of the work vehicle 100 that is output from the positioning device 110 (step S121). Next, the controller 180 calculates a deviation between the position of the work vehicle 100 and a target path (step S122). The target path is defined by positional information (first information) of multiple waypoints that are recorded in the recording mode. The deviation represents a distance between the position of the work vehicle 100 at that moment and the target path. The controller 180 determines whether the calculated deviation in position exceeds a previously-set threshold or not (step S123). If the deviation exceeds the threshold (“Yes” from step S123), the controller 180 changes a control parameter of the steering device 106 included in the driver 240 so that the deviation becomes smaller, thereby changing the steering angle (step S124). If step S123 finds that the deviation does not exceed the threshold (“No” from step S123), the process of step S124 is not performed. Until an instruction to end the reproducing mode is given (step S125), the controller 180 repeats the operation from step S121 to step S124.

In the reproducing mode, by performing the process shown in FIG. 14, for example, the controller 180 causes the work vehicle 100 to perform self-traveling along the target path. Furthermore, based on the state information (second information) corresponding to each of the multiple waypoints defining the target path, the controller 180 may be configured or programmed to control the operation of the work vehicle 100. For example, if the second information includes information of the steering angle of the wheels responsible for steering of the work vehicle 100, in addition to the processing shown in FIG. 14, a control of the steering of the work vehicle 100 may be performed based on the steering angle included in the second information. If the second information includes information of the speed of the work vehicle 100, the speed of the work vehicle 100 is controlled based on the information of speed included in the second information.

For the steering control and speed control of the work vehicle 100, control techniques such as PID control or MPC control (model predictive control) may applied. By applying such control techniques, the control of bringing the work vehicle 100 closer to a target path and a target speed can be made smooth.

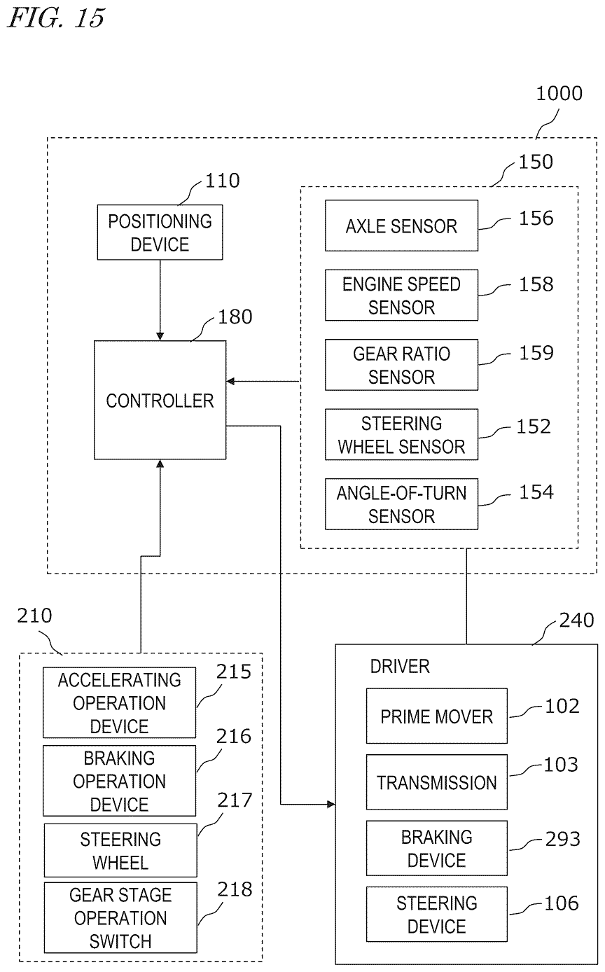

With reference to FIG. 15, an example processing to be performed by the controller 180 in a case where the second information includes information concerning the traveling state of the work vehicle 100 will be described. FIG. 15 is a schematic diagram for describing an example processing to be performed by the controller 180 of the travel control system 1000. In addition to the travel control system 1000, FIG. 15 also shows the driver 240 and the operation switches 210. For simplicity, some component elements are omitted from illustration in FIG. 15.

By controlling the prime mover 102, the braking device (brakes) 293, and the transmission 103 included in the driver 240, the controller 180 controls the speed of the work vehicle 100. The braking device 293 applies braking to the axle that rotates the wheels 104 of the work vehicle 100. Specifically, by controlling the engine speed of the prime mover (engine) 102 and/or the gear ratio of the transmission 103, the speed of the work vehicle 100 can be controlled. For example, the transmission 103 has multiple gear stages, and the controller 180 controls the gear ratio of the transmission 103 by switching the gear stages of the transmission 103. The multiple gear stages of the transmission 103 may be configured by a combination of multiple main gear stages and multiple range gear stages. When the work vehicle 100 is performing manual traveling, the controller 180 controls the speed of the work vehicle 100 by controlling the prime mover 102, the braking device (brakes) 293, and the transmission 103 in response to the driver's manipulation of an accelerating operation device 215 (e.g., an accelerator lever or an accelerator pedal), a braking operation device 216 (e.g., a brake pedal), and/or a gear stage operation switch 218 (e.g., a shift lever). The gear stage operation switch 218 is a switch to select a gear stage of the transmission 103. The controller 180 may further switch between a two-wheel drive mode and a four-wheel drive mode in response to the driver's manipulation.

In the recording mode, the controller 180 consecutively acquires sensor data that is output from vehicle speed sensors such as the axle sensor 156, an engine speed sensor 158, and a gear ratio sensor 159 that detects information of the gear ratio of the transmission 103. Based on such sensor data, as second information, the controller 180 generates and records information of the speed of the work vehicle 100, information of the engine speed of the work vehicle 100, and information of the gear ratio of the transmission 103, in association with the positional information (first information) of each waypoint. In such a case, in the reproducing mode, the controller 180 controls the speed of the work vehicle 100 by controlling the prime mover 102, the transmission 103, and the braking device 293 included in the driver 240 based on the second information that was recorded in the recording mode. The gear ratio sensor 159 may be a sensor which is provided on a rotation axis within the transmission 103 and which detects the gear ratio, or a shift position sensor that detects the position of the shift lever (gear stage operation switch 218) to select a gear stage to identify the selected gear stage. Without being limited to information that indicates the gear ratio itself, information of the gear ratio of the transmission 103 may be information that identifies a selected gear stage among the plurality of gear stages of the transmission 103, for example. Since one gear stage corresponds to one gear ratio, identifying a gear stage allows the gear ratio to be identified.

The work vehicle 100 may have a bi-speed turn mode (front wheel speed increasing function). A bi-speed turn is an operation in which, when a driver steers the steering wheel so much that the steering angle of the front wheels exceeds a threshold, the speed of the front wheels is increased. Performing a bi-speed turn allows the turning radius to be decreased, thus resulting in a smoother turn. The work vehicle 100 may include a solenoid (referred to as a “bi-speed solenoid”) to drive a clutch that switches the bi-speed turn mode ON/OFF. The controller 180 can switch the bi-speed solenoid ON/OFF via a hydraulic circuit. When the bi-speed solenoid is ON, the rotational speed of the front wheels is about twice that of the case where the bi-speed solenoid is OFF.

The second information may further include information concerning the traveling mode of the work vehicle 100. For example, information concerning the traveling mode of the work vehicle 100 may include information as to forward travel or backward travel. Information concerning the traveling mode may include information as to whether the traveling mode of the work vehicle 100 is in a four-wheel drive mode or a two-wheel drive mode. Information concerning the traveling mode may include information as to whether the bi-speed turn mode is ON or OFF. Information concerning the traveling mode may further include information as to whether an automatic single brake mode is ON or OFF. The automatic single brake mode is a mode which, when ON, applies slight braking to the inner rear wheels when the steering angle of the front wheels 104F (which are the wheels responsible for steering) exceeds a predetermined value during travel. In the reproducing mode, the controller 180 controls the traveling mode of the work vehicle 100, by controlling the prime mover 102, the transmission 103, and the braking device 293 included in the driver 240 based on the second information that was recorded in the recording mode.

The controller 180 changes the steering angle of the front wheels 104F (which are the wheels responsible for steering of the work vehicle 100) by controlling the steering device 106, and changes the azimuth of the work vehicle 100 by changing the steering angle of the wheels responsible for steering. When the work vehicle 100 is performing manual traveling, the controller 180 changes the steering angle of the wheels responsible for steering and the azimuth of the work vehicle 100 of the work vehicle 100 by controlling the steering device 106 in response to the driver's manipulation of the steering wheel 217.

In the recording mode, based on sensor data (measurement values) that is output from the steering wheel sensor 152 and/or the angle-of-turn sensor 154, the controller 180 acquires, as second information, information of the steering angle of the wheels responsible for steering of the work vehicle 100. In such a case, in the reproducing mode, the controller 180 controls steering of the work vehicle 100 by controlling the hydraulic device or the electric motor included in the steering device 106 based on the second information that was recorded in the recording mode.

The second information may further include information concerning the attitude of the work vehicle 100. The attitude of the work vehicle 100 is represented by a roll angle θ_{R}, a pitch angle θ_{P}, and a yaw angle θ_{Y}, for example. A roll angle θ_{R} represents the amount of rotation of the work vehicle 100 around its front-rear axis. A pitch angle θ_{P} represents the amount of rotation of the work vehicle 100 around its right-left axis. A yaw angle θ_{Y} represents the amount of rotation of the work vehicle 100 around its top-bottom axis. The attitude may be defined by an Euler angle or other angles, or a quaternion. The controller 180 acquires information concerning the attitude of the work vehicle 100 based on data that is output from the IMU 115, for example.

Now, specific examples of the recording start condition and the recording end condition will be described. Each of the recording start condition and the recording end condition stipulates satisfying all of any two or more conditions that are described as specific examples below. Hereinafter, together with the specific examples of the respective conditions, examples of processing to be performed by the controller 180 will be described.

The recording start condition and/or the recording end condition may include that “the work vehicle 100 is stopped”. That “the work vehicle 100 is stopped” is synonymous to that “the work vehicle 100 has zero speed”. By including this condition, reproducibility of the operation of the work vehicle 100 in the reproducing mode can be enhanced. Based on sensor data that is output from a vehicle speed sensor such as the axle sensor 156 and the gear ratio sensor 159 that detects information of the gear ratio of the transmission 103, the controller 180 acquires any one or more of information of the speed of the work vehicle 100, information of the engine speed of the work vehicle 100, and information of the gear ratio of the transmission 103. The controller 180 may acquire information of the speed of the work vehicle 100 based on sensor data that is output from the IMU 115. Based on the acquired information, the controller 180 determines whether the work vehicle 100 is stopped or not. The controller 180 may acquire information of the speed of the work vehicle 100 by acquiring information of rate of change in the position of the work vehicle 100 per unit time based on position data that is output from the positioning device 110.

The recording start condition and/or the recording end condition may include that “the prime mover 102 of the work vehicle 100 is working”. By including the above condition, recording of position data in the recording mode can be smoothly performed, and reproducibility of the operation of the work vehicle 100 in the reproducing mode can be enhanced. Based on sensor data that is output from the engine speed sensor 158, for example, the controller 180 determines whether the prime mover 102 is working or not.

The recording start condition and/or the recording end condition may include that “the roll angle of the work vehicle 100 has a predetermined value or below” and/or that “the pitch angle of the work vehicle 100 has a predetermined value or below”. The tilt angle (roll angle and/or pitch angle) of the work vehicle 100 being too large is undesirable for carrying out reproduction in the reproducing mode. By including this condition, reproducibility of the operation of the work vehicle 100 in the reproducing mode can be enhanced. Based on sensor data that is output from the IMU 115, the controller 180 acquires information of the attitude of the work vehicle 100, and based on the acquired information, determines whether or not the tilt angle of the work vehicle 100 has a predetermined value or below.

The recording start condition and/or the recording end condition may include that “reception of satellite signals by the positioning device 110 is sufficient”. That “reception of satellite signals by the positioning device 110 is sufficient” includes that “reception problems do not exist regarding satellite signals for the positioning device 110”, for example. A “reception problem for satellite signals” refers to a state where poorer reception of satellite signals has resulted in a lower positioning reliability than at normal times. In such a state, the reliability of position data that is output from the positioning device 110 may deteriorate, which is not suitable for recording of position data. A reception problem may occur when the number of detected satellites is small (e.g., three or fewer), when the reception intensity for each satellite signal is low, or when multipath exists, for example. The controller 180 can determine the presence/absence of reception problems based on information concerning satellites that is included in GNSS data, for example. For example, the presence/absence of reception problems can be determined based on the satellite-by-satellite value of reception intensity included in GNSS data or a value indicating DOP (Dilution of Precision) of deployment status of satellites, etc.

The recording start condition and/or the recording end condition may include that “the traveling mode of the work vehicle 100 is a predetermined traveling mode”. For example, the recording start condition and/or the recording end condition may stipulate a traveling mode that is suitable for self-traveling in the reproducing mode, whereby reproducibility of the operation of the work vehicle 100 in the reproducing mode can be enhanced. Depending on the path for which to generate path data (e.g., depending on whether the path is outside the field or inside the field), the “predetermined traveling mode” may vary.

For example, in a case the aforementioned bi-speed turn mode can be switched ON or OFF as a traveling mode for the where work vehicle 100, the “predetermined traveling mode” includes the bi-speed turn mode being OFF, for example. In the case of generating path data for a path outside the field, it is preferable that the bi-speed turn mode is OFF, from the standpoint of achieving smooth self-traveling of the work vehicle 100 outside the field in the reproducing mode.

For example, in a case where the aforementioned automatic single brake mode is switchable between ON and OFF as a traveling mode for the work vehicle 100, the “predetermined traveling mode” includes the automatic single brake mode being OFF, for example. In the case of generating path data for a path outside the field, it is preferable that the automatic single brake mode is OFF, from the standpoint of achieving smooth self-traveling of the work vehicle 100 outside the field in the reproducing mode.

In the case of generating path data for a path interconnecting fields in the recording mode, the recording start condition may include that “the work vehicle 100 is in a predetermined region within the pre-move field”. The recording end condition may include that “the work vehicle 100 is in a predetermined region within a post-move field”. For example, as in the example of FIG. 5A, the recording start condition may include that the start point of the path is in the predetermined region 71a that is predefined within the pre-move field (first field) 70a. The recording end condition may include that the end point of the path is in the predetermined region 71b that is predefined within the post-move field (second field) 70b. The predetermined region 71a, 71b is set by the user, for example. By setting the start point and/or the end point of the path for which to generate path data within a predetermined region(s), it becomes possible to generate path data in accordance with the needs that call for performing self-traveling in the reproducing mode.

Information of the predetermined region 71a, 71b is recorded in a storage device that is accessible to the controller 180, for example. The controller 180 determines whether the work vehicle 100 is in the predetermined region 71a within a pre-move field or whether the work vehicle 100 is in the predetermined region 71b within a pre-move field based on position data that is output from the positioning device 110 and information of the predetermined region 71a, 71b.

In a case where the work vehicle 100 has the implement 300 linked thereto, the recording start condition and/or the recording end condition may include that “rotation of the PTO shaft is OFF” and/or that “height of the three-point hitch has a predetermined value or above”. For example, in the case of generating path data for a path interconnecting fields in the recording mode, including the aforementioned condition(s) in the recording start condition and/or the recording end condition allows smooth self-traveling to be performed outside the field in the reproducing mode.

The linkage device 108 for connecting the implement 300 includes a PTO shaft to supply rotation-based motive power to the implement 300 and a three-point hitch to adjust the height of the implement 300. The sensor group 150 includes a PTO sensor to detect rotation ON/OFF of the PTO shaft and a 3P position sensor to detect the height position of the three-point hitch. Based on sensor data that is output from the PTO sensor, the controller 180 acquires information concerning rotation ON or OFF of the PTO shaft, and determines whether rotation of the PTO shaft is OFF or not. Based on sensor data that is output from the 3P position sensor, the controller 180 acquires information concerning the height of the three-point hitch, and determines whether the height of the three-point hitch has a predetermined value or above.

Travel control systems according to example embodiments of the present invention are not limited to what has been illustrated. For instance, although the above-described example illustrates a case where path data is generated with respect to paths interconnecting fields, this is not a limitation. For example, path data may be generated with respect to paths along which the work vehicle travels within a field. Path data may be generated with respect to paths along which the work vehicle travels within a field while performing work by using an implement.

The travel control systems according to the above example embodiments may be mounted to work vehicles lacking such functionality as an add-on. Such a control system may be manufactured and marketed independently from the work vehicle. A computer program for use in such a control system may also be manufactured and marketed independently from the work vehicle. The computer program may be provided in a form stored in a computer-readable, non-transitory storage medium, for example. The computer program may also be provided through downloading via telecommunication lines (e.g., the Internet).

The travel control systems according to example embodiments of the present invention are broadly applicable to various kinds of work vehicles for use in smart agriculture.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A travel control system for a work vehicle, comprising:
a positioning device to output position data concerning a position of the work vehicle; and
a controller configured or programmed to:
control operation of the work vehicle;
operate in a recording mode to record to a storage device the position data as acquired while the work vehicle travels;
operate in a reproducing mode to cause the work vehicle to travel via self-driving by controlling speed and steering of the work vehicle based on the position data recorded in the storage device; and
when a manipulation for beginning recording of the position data to the storage device is performed, determine whether a start condition for beginning recording of the position data is satisfied or not, the start condition stipulating that all of a plurality of conditions are satisfied, and cause a notifier to output a notification as to whether the start condition is satisfied or not.

2. The travel control system of claim 1, wherein the notification includes a first notification indicating, when the start condition is determined as satisfied, that the start condition is satisfied.

3. The travel control system of claim 2, wherein the notification includes a second notification indicating, when the start condition is determined as not satisfied, a condition among the plurality of conditions that is unsatisfied.

4. The travel control system of claim 3, wherein
the notifier includes a display device to display the notification; and
the controller is configured or programmed to, after causing the second notification to be displayed on the display device, erase the second notification when the unsatisfied condition becomes satisfied.

5. The travel control system of claim 1, wherein the notification includes a third notification indicating, when the start condition is determined as not satisfied, a manipulation to be performed in order to satisfy a condition among the plurality of conditions that is unsatisfied.

6. The travel control system of claim 5, wherein
the notifier includes a display device to display the notification; and
the controller is configured or programmed to, after causing the third notification to be displayed on the display device, erase the third notification when the unsatisfied condition becomes satisfied.

7. The travel control system of claim 1, wherein the plurality of conditions include any two or more of:
that a roll angle of the work vehicle has a predetermined value or below;
that a pitch angle of the work vehicle has a predetermined value or below;
that the work vehicle is stopped;
that a prime mover of the work vehicle is working; and
that reception of a satellite signal by the positioning device is sufficient.

8. The travel control system of claim 1, wherein the plurality of conditions include that the work vehicle is in a predetermined traveling mode.

9. The travel control system of claim 1, wherein
in the recording mode, the work vehicle travels along a path connecting a first field and a second field;
the notifier includes a display device to display the notification; and
the controller is configured or programmed to, prior to the recording mode, cause the display device to display a graphical user interface (GUI) configured to allow a user to set the first field and the second field.

10. The travel control system of claim 9, wherein the plurality of conditions include that the work vehicle is in a predetermined region within the first field.

11. The travel control system of claim 1, wherein
the work vehicle has an implement linked thereto;
the work vehicle includes a linkage device to connect the implement;
the linkage device includes a PTO shaft to supply motive power to the implement and a three-point hitch to adjust a height of the implement; and
the plurality of conditions include one or more of:
that rotation of the PTO shaft is OFF; and
that a height of the three-point hitch has a predetermined value or above.

12. The travel control system of claim 1, wherein the controller is configured or programmed to, when a manipulation for ending the recording mode is performed by a user, determine whether an end condition for ending the recording mode is satisfied or not, the end condition stipulating that all of a plurality of conditions are satisfied, and cause the notifier to output another notification as to whether the end condition is satisfied or not.

13. The travel control system of claim 12, wherein the another notification includes a fourth notification indicating, when the end condition is determined as satisfied, that the end condition is satisfied.

14. The travel control system of claim 12, wherein the another notification includes a fifth notification indicating, when the end condition is determined as not satisfied, a condition among the plurality of conditions defining the end condition that is unsatisfied.

15. The travel control system of claim 14, wherein
the notifier includes a display device to display the notification;
the controller is configured or programmed to, after causing the fifth notification to be displayed on the display device, erase the fifth notification when the unsatisfied condition becomes satisfied.

16. The travel control system of claim 12, wherein the another notification includes a sixth notification indicating, when the end condition is determined as not satisfied, a manipulation to be performed in order to satisfy a condition among the plurality of conditions defining the end condition that is unsatisfied.

17. The travel control system of claim 16, wherein
the notifier includes a display device to display the notification,
the controller is configured or programmed to, after causing the sixth notification to be displayed on the display device, erase the sixth notification when the unsatisfied condition becomes satisfied.

18. A work vehicle comprising:
the travel control system of claim 1;
a travel device including a wheel responsible for steering; and
a driver to drive the travel device; wherein
in the reproducing mode, the controller is configured or programmed to cause the work vehicle to travel via self-driving by controlling the driver based on the position data recorded in the storage device.

19. A method of travel control for a work vehicle, to be executed by a controller configured or programmed to control operation of the work vehicle and operate in a recording mode and a reproducing mode, the method comprising:
in the recording mode, recording position data concerning a position of the work vehicle as acquired while the work vehicle travels to a storage device;
in the reproducing mode, causing the work vehicle to travel via self-driving by controlling speed and steering of the work vehicle based on the position data recorded in the storage device; and
when a manipulation for beginning recording of the position data to the storage device is performed, determining whether a start condition for beginning recording of the position data is satisfied or not, the start condition stipulating that all of a plurality of conditions are satisfied, and causing a notifier to output a notification as to whether the start condition is satisfied or not.

20. A non-transitory computer-readable medium including a computer program to be executed by a processor in a controller configured or programmed to control operation of a work vehicle and operate in a recording mode and a reproducing mode, the computer program is executable to cause the processor to perform:
in the recording mode, recording position data concerning a position of the work vehicle as acquired while the work vehicle travels to a storage device;
in the reproducing mode, causing the work vehicle to travel via self-driving by controlling speed and steering of the work vehicle based on the position data recorded in the storage device; and,
when a manipulation for beginning recording of the position data to the storage device is performed, determining whether a start condition for beginning recording of the position data is satisfied or not, the start condition stipulating that all of a plurality of conditions are satisfied, and causing a notifier to output a notification as to whether the start condition is satisfied or not.
